(19) United States
(12) Patent Application Publication
(10) Pub. No.: US 2023/0251585 A1
(43) Pub. Date: Aug. 10, 2023

(54) ELECTROPHOTOGRAPHIC PHOTORECEPTOR, PROCESS CARTRIDGE, AND IMAGE FORMING APPARATUS

(71) Applicant: Fujifilm Business Innovation Corp., Tokyo (JP)

(72) Inventors: Masahiro IWASAKI, Kanagawa (JP); Yuki Oyamada, Kanagawa (JP); Keisuke Kusano, Kanagawa (JP); Wataru Yamada, Kanagawa (JP)

(73) Assignee: Fujifilm Business Innovation Corp., Tokyo (JP)

(21) Appl. No.: 17/902,401

(22) Filed: Sep. 2, 2022

(30) Foreign Application Priority Data
Feb. 8, 2022 (JP) 2022-017983

(51) Int. Cl. G03G 5/05; G03G 5/14; G03G 5/06; G03G 21/18

(52) U.S. Cl. CPC G03G 5/056; G03G 5/142; G03G 5/06142; G03G 5/06144; G03G 21/1814

(57) ABSTRACT

An electrophotographic photoreceptor includes a conductive substrate, an undercoat layer on the conductive substrate, and a photosensitive layer on the undercoat layer, in which the undercoat layer is formed of a cured product of a composition that contains a reactive group-containing triarylamine compound, a curing agent, and an electron transport material and that has a butyral resin content of 0 mass % or more and 5 mass % or less relative to all solid components in the undercoat layer.

### CROSS-REFERENCE TO RELATED APPLICATIONS

This application is based on and claims priority under 35 USC 119 from Japanese Patent Application No. 2022-017983 filed Feb. 8, 2022.

### BACKGROUND

### (i) Technical Field

The present disclosure relates to an electrophotographic photoreceptor, a process cartridge, and an image forming apparatus.

### (ii) Related Art

Japanese Unexamined Patent Application Publication No. 2011-095665 discloses an electrophotographic photoreceptor that includes a conductive support, an intermediate layer, and a photosensitive layer that are stacked on top of each other in this order, in which the intermediate layer contains a polyolefin and a benzimidazole compound.

Japanese Patent No. 3958154 discloses an electrophotographic photoreceptor that includes a support, an intermediate layer, and a photosensitive layer that are stacked on top of each other in this order, in which the intermediate layer contains an electron transport substance selected from a naphthalene amidine imide compound, a perylene amidine imide compound, and an imide resin.

Japanese Patent No. 3958155 discloses an electrophotographic photoreceptor that includes a support, an intermediate layer, and a photosensitive layer that are stacked on top of each other in this order, in which the intermediate layer contains an electron transport substance selected from a naphthalene amidine imide compound and a perylene amidine imide compound.

Japanese Unexamined Patent Application Publication No. 2015-026067 discloses a benzimidazole compound as an electron transport substance used in an undercoat layer of an electrophotographic photoreceptor.

Japanese Unexamined Patent Application Publication No. 2014-186296 discloses an electrophotographic photoreceptor that includes a support, an undercoat layer, and a photosensitive layer, in which the undercoat layer contains metal oxide particles surface-treated with a silane coupling agent, a binder resin, and an organic acid salt of a metal selected from bismuth, zinc, cobalt, iron, nickel, and copper.

### SUMMARY

Typically, a material used in the undercoat layer of an electrophotographic photoreceptor is a polycyclic electron transport material having a high electron transport property; however, the desirable performance for the undercoat layer is a high charge-retaining property. It is considered that holes, which serve as a minority carrier in the electron transport material, contribute to this charge-retaining property. Aspects of non-limiting embodiments of the present disclosure relate to an electrophotographic photoreceptor that exhibits a good charge-retaining property and a low residual potential compared to an electrophotographic photoreceptor that includes an undercoat layer containing more than 5 mass % of a butyral resin relative to all solid components of the undercoat layer.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an electrophotographic photoreceptor including a conductive substrate, an undercoat layer on the conductive substrate, and a photosensitive layer on the undercoat layer, in which the undercoat layer is formed of a cured product of a composition that contains a reactive group-containing triarylamine compound, a curing agent, and an electron transport material and that has a butyral resin content of 0 mass % or more and 5 mass % or less relative to all solid components in the undercoat layer.

### BRIEF DESCRIPTION OF THE DRAWINGS

Exemplary embodiments of the present disclosure will be described in detail based on the following figures, wherein:

FIG. 1 is a schematic partial cross sectional view illustrating one example of a layer structure of an electrophotographic photoreceptor according to an exemplary embodiment;

FIG. 2 is a schematic diagram illustrating one example of an image forming apparatus according to an exemplary embodiment; and

FIG. 3 is a schematic diagram illustrating another example of the image forming apparatus according to an exemplary embodiment.

### DETAILED DESCRIPTION

The exemplary embodiments of the present disclosure will now be described. These disclosures and examples are used to describe, but not limit the scope of, the exemplary embodiments.

In this disclosure, a numerical range described by using “to” includes the number preceding “to” as the minimum value and the number following “to” as the maximum value.

In numerical ranges described stepwise in this disclosure, the upper limit or the lower limit of one numerical range may be substituted with an upper limit or a lower limit of a different numerical range also described stepwise. Furthermore, in any numerical range described in this disclosure, the upper limit or the lower limit of the numerical range may be substituted with a value indicated in Examples.

In this disclosure, the term “step” refers not only to an independent step but also to any feature that fulfills the intended purpose of that step although such a feature may not be clearly distinguishable from other steps.

In the present disclosure, each of the components may contain more than one corresponding substances. When an amount of any component in a composition is described in the present disclosure and when there are more than one substances that correspond to that component in the composition, the amount of the component is the total amount of the more than one corresponding substances present in the composition unless otherwise noted.

In this disclosure, a main component means a component used as a key component. For example, the main component is a component that accounts for 30 mass % or more of the total mass of a mixture of more than one components.

In the present disclosure, the electrophotographic photoreceptor may be simply referred to as a photoreceptor.

### Electrophotographic Photoreceptor

The photoreceptor according to an exemplary embodiment is equipped with a conductive substrate, an undercoat layer on the conductive substrate, and a photosensitive layer on the undercoat layer.

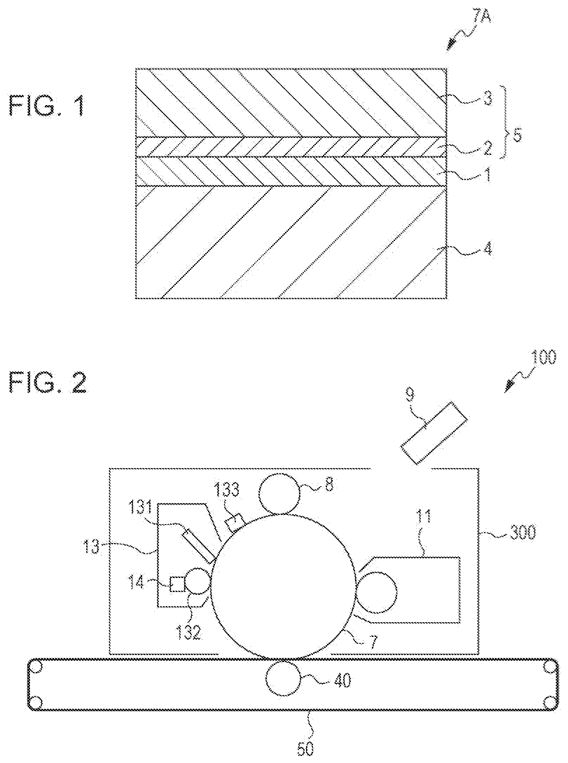

FIG. 1 schematically illustrates one example of a layer structure of a photoreceptor according to this exemplary embodiment. A photoreceptor 7A illustrated in FIG. 1 has a structure in which an undercoat layer 1, a charge generation layer 2, and a charge transport layer 3 are stacked in this order on a conductive substrate 4. The charge generation layer 2 and the charge transport layer 3 constitute a photosensitive layer 5. The photoreceptor 7A may have a layer structure in which a protection layer is further provided on the charge transport layer 3.

The photosensitive layer of the photoreceptor of this exemplary embodiment may be a function-separated photosensitive layer in which the charge generation layer 2 and the charge transport layer 3 are separately provided as in the photoreceptor 7A illustrated in FIG. 1, or may be a single-layer photosensitive layer that has a charge generation ability and a charge transport ability instead of the charge generation layer 2 and the charge transport layer 3.

The electrophotographic photoreceptor of this exemplary embodiment includes a conductive substrate, an undercoat layer on the conductive substrate, and a photosensitive layer on the undercoat layer. The undercoat layer is formed of a cured product of a composition that contains a reactive group-containing triarylamine compound, a curing agent, and an electron transport material and has a butyral resin content of 0 mass % or more and 5 mass % or less relative to all solid components in the undercoat layer.

A photoreceptor that includes an undercoat layer that contains an electron transport material has a reduced residual potential. However, a typical photoreceptor that includes an undercoat layer that contains an electron transport material does not have a sufficient charge-retaining property. The cause behind this is not exactly clear but is presumably that migration of minority holes in the electron transport material contained in the undercoat layer after charging induces injection of charges into the charge generation material (for example, a phthalocyanine pigment) contained in the photosensitive layer and thereby causes potential decay on the photoreceptor surface.

The studies conducted by the present inventors have revealed that when a curing agent and a reactive group-containing triarylamine compound are contained in the undercoat layer-constituting composition along with an electron transport material, the charge-retaining property is improved. The mechanism thereof is presumably that the triarylamine compound serves as an electron donor and captures the holes, which serve as a minority carrier in the electron transport material, and thus strengthens the effect of blocking injection into the charge generation material. Furthermore, the reactive group in the triarylamine improves the compatibility with the curing agent and the butyral resin; thus, the number of unreacted residues in the cured film can be decreased, and the cured product becomes less susceptible to the influence of various environments ranging from high-temperature, high-humidity to low-temperature, low humidity. Presumably as a result, potential decay on the surface of the photoreceptor is inhibited, and the potential becomes stable.

In this exemplary embodiment, it is considered that since the reactive group-containing triarylamine compound is contained, the reactive group of the triarylamine compound reacts and polymerizes with the curing agent, and curing progresses while retaining good compatibility, thereby improving the film forming property. In addition, it is considered that since the triarylamine compound serves as an electron donor for the holes in the electron transport material, hole migration from the electron transport material to the charge generation layer is suppressed.

By maintaining a butyral resin content of 5 mass % or less relative to all solid components in the undercoat layer, the number of unreacted groups in the undercoat layer can be decreased, the stability of repeating properties of the photoreceptor with small environmental fluctuation is improved without impairing the electron transport property of the electron transport material.

As mentioned above, the electrophotographic photoreceptor of this exemplary embodiment has an excellent charge-retaining property and decreases the residual potential.

Hereinafter, the individual layers of the electrophotographic photoreceptor of this exemplary embodiment are described in detail. The reference signs are omitted in the description below.

### Undercoat Layer

### Cured Product of a Composition Constituting the Undercoat Layer

The undercoat layer is formed of a cured product of a composition that contains a reactive group-containing triarylamine compound, a curing agent, and an electron transport material and that has a butyral resin content of 0 mass % or more and 5 mass % or less relative to all solid components in the undercoat layer. The composition may further contain, if needed, other curing agents, inorganic particles, curing catalysts, additives, etc., in addition to the materials described above.

### Reactive Group-Containing Triarylamine Compound

The reactive group-containing triarylamine compound refers to a triarylamine compound that has a group that can react with and be polymerized with at least an isocyanate compound contained in the composition.

Examples of the reactive group include a hydroxyl group, an amide group, an amino group (NH₂ group), a hydroxyalkyl group, a thiol group, an alkylthiol group, a carboxy group, and a carboxyalkyl group.

The reactive group-containing triarylamine compound may contain a hole transport compound represented by general formula (I) below. When a hole transport compound represented by general formula (I) is contained, the triarylamine compound serves as an electron donor for the holes in the electron transport material, hole migration to the charge generation layer is further suppressed, and thus the charge-retaining property is further improved.

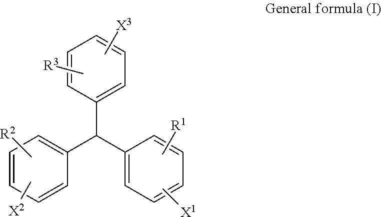

In general formula (I), R¹, R², and R³ (hereinafter, may simply be referred to as “R¹ to R³”) each independently represent a hydrogen atom, a hydroxyl group, a hydroxyalkyl group having 1 to 6 carbon atoms, an amino group (NH₂ group), a thiol group, an alkylthiol group, a carboxy group, or a carboxyalkyl group, and X¹, X², and X³ (hereinafter, may simply be referred to as “X¹ to X³”) each independently represent a halogen atom, an alkyl group, an alkoxy group, an ester group, an aryl group, an aralkyl group, or a vinylphenyl group (styryl group).

Examples of the hydroxyalkyl group having 1 to 6 carbon atoms represented by R¹ to R³ in general formula (I) include a hydroxymethyl group, a hydroxyethyl group, a hydroxybutyl group, a hydroxypropyl group, a hydroxypentyl group, and a 2-hydroxypropyl group. Among these, a hydroxyalkyl group having 1 to 5 carbon atoms is preferable and a hydroxyalkyl group having 1 to 3 carbon atoms is more preferable.

The alkylthiol group (—R—SH where R represents an alkyl chain) represented by R¹ to R³ in general formula (I) is preferably an alkylthiol group having 1 to 10 carbon atoms, more preferably an alkylthiol group having 1 to 5 carbon atoms, and yet more preferably an alkylthiol group having 1 to 3 carbon atoms.

Examples of the alkylthiol group having 1 to 10 carbon atoms include a methylthiol group, an ethylthiol group, a propylthiol group, a tert-butylthiol group, an octylthiol group, and a nonylthiol group.

The carboxyalkyl group represented by R¹ to R³ in general formula (I) is preferably a carboxyalkyl group having 2 to 10 carbon atoms, more preferably a carboxyalkyl group having 2 to 6 carbon atoms, and yet more preferably a carboxyalkyl group having 2 to 4 carbon atoms.

Examples of the carboxyalkyl group having 2 to 10 carbon atoms include a 2-carboxyethyl group, a 3-carboxypropyl group, a 4-carboxybutyl group, and a carboxymethyl group.

Examples of the halogen atom represented by X¹ to X³ in general formula (I) include a fluorine atom, a bromine atom, and an iodine atom.

Examples of the alkyl group represented by X¹ to X³ in general formula (I) include linear alkyl groups having 1 to 10 carbon atoms (preferably 1 to 5 carbon atoms and more preferably 1 to 3 carbon atoms), branched alkyl groups having 3 to 10 carbon atoms (preferably 3 to 6 carbon atoms), and cyclic alkyl groups having 3 to 10 carbon atoms (preferably 3 to 6 carbon atoms).

Examples of the linear alkyl groups having 1 to 10 carbon atoms include a methyl group, an ethyl group, an n-propyl group, an n-butyl group, an n-pentyl group, an n-hexyl group, an n-heptyl group, an n-octyl group, an n-nonyl group, and an n-decyl group.

Examples of the branched alkyl groups having 3 to 10 carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the alkoxy group represented by X¹ to X³ in general formula (I) include linear, branched, and cyclic alkoxy groups having 1 to 10 carbon atoms (preferably 1 to 6 and more preferably 1 to 4 carbon atoms).

Specific examples of the linear alkoxy group include a methoxy group, an ethoxy group, an n-propoxy group, an n-butoxy group, an n-pentyloxy group, an n-hexyloxy group, an n-heptyloxy group, an n-octyloxy group, an n-nonyloxy group, and an n-decyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

Specific examples of the cyclic alkoxy group include a cyclopropoxy group, a cyclobutoxy group, a cyclopentyloxy group, a cyclohexyloxy group, a cycloheptyloxy group, a cyclooctyloxy group, a cyclononyloxy group, and a cyclodecyloxy group

The aryl group represented by X¹ to X³ in general formula (I) is preferably an aryl group having 6 to 20 carbon atoms, more preferably an aryl group having 6 to 14 carbon atoms, and yet more preferably an aryl group having 6 to 12 carbon atoms.

Examples of the aryl group having 6 to 20 carbon atoms include a phenyl group, a biphenyl group, a 1-naphthyl group, a 2-naphthyl group, a 9-anthryl group, a 9-phenanthryl group, a 1-pyrenyl group, a 5-naphthacenyl group, a 1-indenyl group, a 2-azulenyl group, a 9-fluorenyl group, a biphenylenyl group, an indacenyl group, a fluoranthenyl group, an acenaphthylenyl group, an aceanthrylenyl group, a phenalenyl group, a fluorenyl group, and an anthryl group.

The aralkyl group represented by X¹ to X³ in general formula (I) is preferably an aralkyl group having 7 to 20 carbon atoms, more preferably an aralkyl group having 7 to 15 carbon atoms, and yet more preferably an aralkyl group having 7 to 10 carbon atoms.

Examples of the unsubstituted aralkyl group having 7 to 20 carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthratylmethyl group, and a phenyl-cyclopentylmethyl group.

In a hole transport compound represented by general formula (I) according to one exemplary embodiment, R¹, R², and R³ in general formula (I) may each independently represent a hydrogen atom, a hydroxyl group, a hydroxyalkyl group having 1 to 4 carbon atoms, an amino group (NH₂ group), a carboxy group, or a carboxyalkyl group having 1 to 4 carbon atoms, and X¹, X², and X³ may each independently represent a hydrogen atom, an alkyl group having 1 to 3 carbo atoms, an aryl group, or a vinylphenyl group (styryl group). When the groups represented by R¹ to R³ and X¹ to X³ in general formula (I) are groups described above and when the composition is cured into a cured product, the reactive group-containing triarylamine compound easily reacts with the isocyanate compound and the like contained in the composition. As a result, the film-forming property of the undercoat layer is improved, hole migration is further reduced, and thus the charge-retaining property is further improved.

In the description below, example compounds of the hole transport compound represented by general formula (I) are described, and these examples are not limiting.

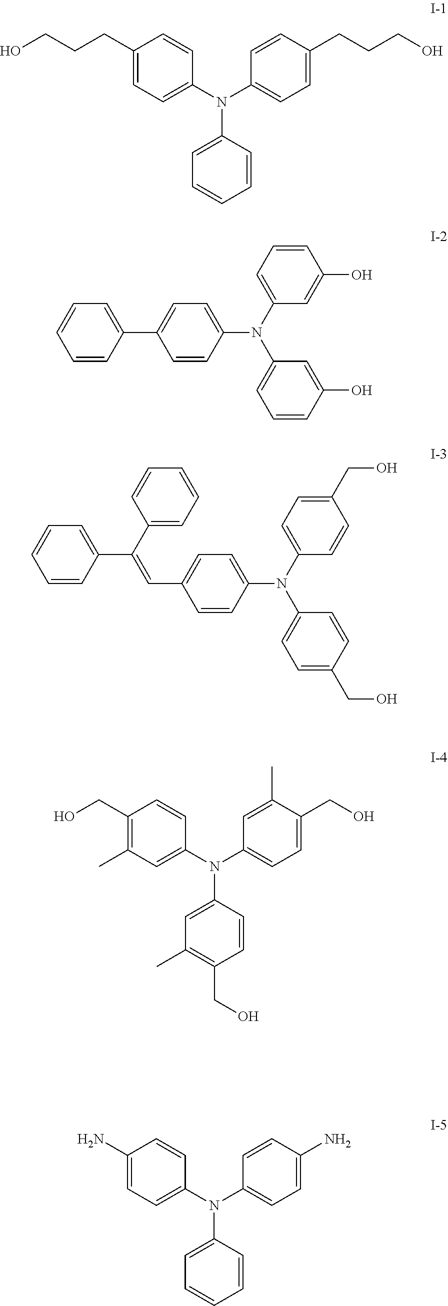

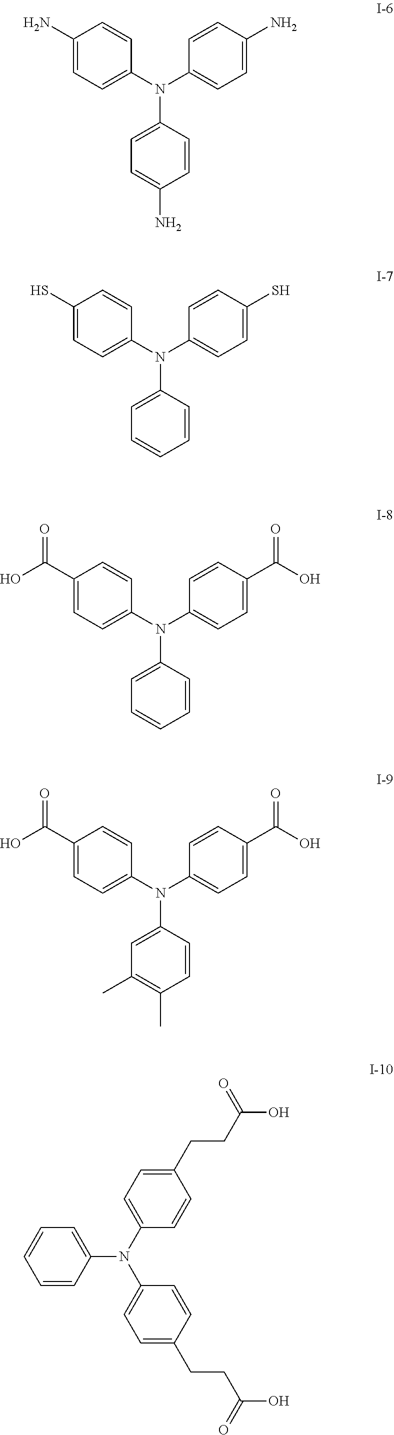

The reactive group-containing triarylamine compound content relative to all solid components in the undercoat layer is preferably 0.1 mass % or more and 10 mass % or less, more preferably 1 mass % or more and 8 mass % or less, and yet more preferably 2 mass % or more and 5 mass % or less.

When the reactive group-containing triarylamine compound content relative to all solid components in the undercoat layer is 0.1 mass % or more, the charge-retaining property is further improved. At a content of 10 mass % or less, defects in the coating film caused by crystallization of the unreacted reactive group-containing triarylamine compound remaining in the cured film are reduced, and better a better charge-retaining property is obtained.

### Electron Transport Material

Examples of the electron transport material include electron transport compounds such as perinone compounds; naphthalenetetracarboxydiimide compounds; diimide perylenetetracarboxylate compounds; quinone compounds such as p-benzoquinone, chloranil, bromanil, and anthraquinone; tetracyanoquinodimethane compounds; fluorenone compounds such as 2,4,7-trinitrofluorenone; dinaphthoquinone compounds; diphenoquinone compounds; xanthone compounds; benzophenone compounds; cyanovinyl compounds; and ethylene compounds. These electron transport materials may be used alone or in combination as a mixture.

The electron transport material preferably contains at least one electron transport material selected from the group consisting of compounds represented by general formula (1), general formula (2), general formula (3), general formula (4), general formula (5), general formula (6), general formula (7), and general formula (8) below, more preferably contains at least one electron transport material selected from the group consisting of compounds represented by general formula (1), general formula (2), general formula (3), general formula (7), and general formula (8) below, more preferably contains at least one electron transport material selected from the group consisting of compounds represented by general formula (1), general formula (2), and general formula (7) below, and yet more preferably contains at least one electron transport material selected from the group consisting of compounds represented by general formula (1) and general formula (2) below.

The compounds represented by general formula (1), general formula (2), general formula (3), general formula (4), general formula (5), general formula (6), general formula (7), and general formula (8) (more preferably compounds represented by general formula (1) and general formula (2)) used as the electron transport material have excellent dispersion stability in a mixture containing a curing agent, an isocyanate compound, and a solvent (in particular, a solvent such as an ester or a ketone), and thus the film forming property of the undercoat layer is easily improved. Thus, when at least one electron transport material selected from the group consisting of these compounds is contained, the electron transport material becomes easily dispersible in the undercoat layer, and thus, uniform electron transport is possible within the film, and presumably thus the residual potential is further reduced due to the excellent electron transport property.

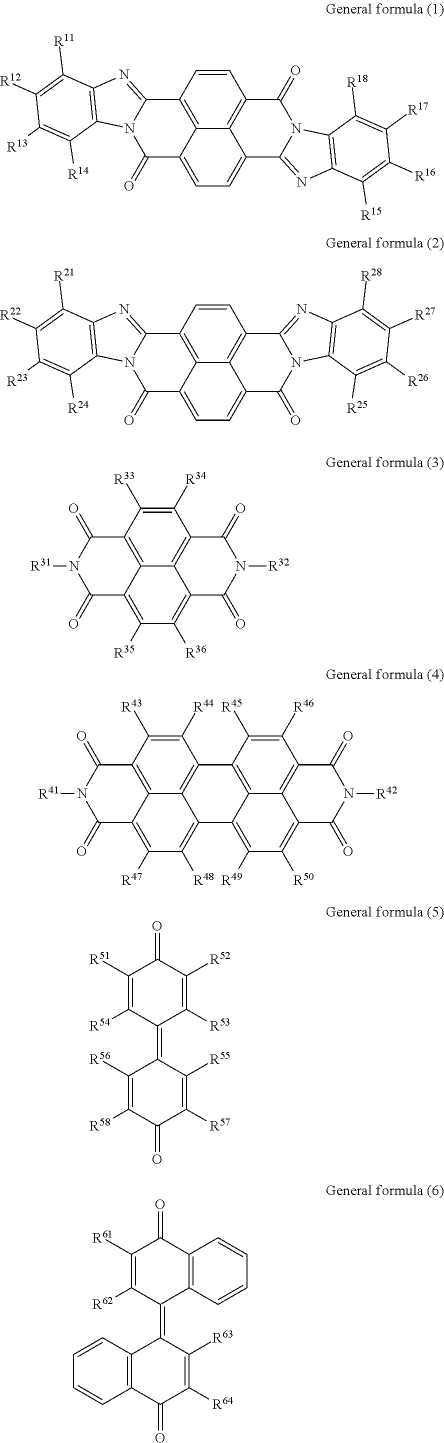

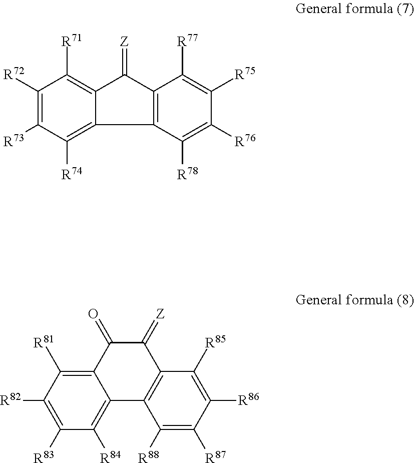

In general formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom. R¹¹ and R¹² taken together may form a ring, and so may R¹² and R¹³, and R¹³ and R¹⁴. R¹⁵ and R¹⁶ taken together may form a ring, and so may R¹⁶ and R¹⁷, and R¹⁷ and R¹⁸.

In general formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom. R²¹ and R²² taken together may form a ring, and so may R²² and R²³, and R²³ and R²⁴. R²⁵ and R²⁶ taken together may form a ring, and so may R²⁶ and R²⁷, and R²⁷ and R²⁸.

In general formula (3), R³¹, R³², R³³, R³⁴, R³⁵, and R³⁶ each independently represent a hydrogen atom, an alkyl group, an alkoxy group, an aralkyl group, an aryl group, an alkoxycarbonyl group, or a halogen atom.

In general formula (4), R⁴¹, R⁴², R⁴³, R⁴⁴, R⁴⁵, R⁴⁶, R⁴⁷, R⁴⁸, R⁴⁹, and R⁵⁰ each independently represent a hydrogen atom, an alkyl group, an alkoxy group, an aralkyl group, an aryl group, an alkoxycarbonyl group, or a halogen atom.

In general formula (5), R⁵¹, R⁵², R⁵³, R⁵⁴, R⁵⁵, R⁵⁶, R⁵⁷, and R⁵⁸ each independently represent a hydrogen atom, an alkyl group, an alkoxy group, an aralkyl group, an aryl group, an alkoxycarbonyl group, or a halogen atom.

In general formula (6), R⁶¹, R⁶², R⁶³, and R⁶⁴ each independently represent a hydrogen atom, an alkyl group, an alkoxy group, an aralkyl group, an aryl group, an alkoxycarbonyl group, or a halogen atom.

In general formula (7), R⁷¹, R⁷², R⁷³, R⁷⁴, R⁷⁵, R⁷⁶, R⁷⁷, and R⁷⁸ each independently represent a hydrogen atom, an alkyl group, an alkoxy group, an aralkyl group, an aryl group, an acyl group, an alkoxycarbonyl group, or a halogen atom, and Z represents an oxygen atom or a dicyanomethylene group (═C(CN)₂).

In general formula (8), R⁸¹, R⁸², R⁸³, R⁸⁴, R⁸⁵, R⁸⁶, R⁸⁷, and R⁸⁸ each independently represent a hydrogen atom, an alkyl group, an alkoxy group, an aralkyl group, an aryl group, an acyl group, an alkoxycarbonyl group, or a halogen atom, and Z represents an oxygen atom or a dicyanomethylene group (═C(CN)₂).

### Compounds Represented by General Formula (1) and General Formula (2)

Compounds represented by general formula (1) and general formula (2) will now be described.

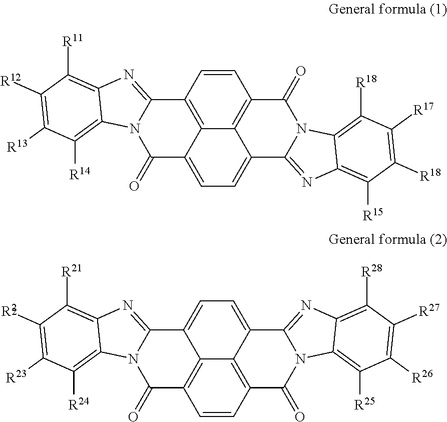

In general formula (1), R¹¹, R¹², R¹³, R¹⁴, R¹⁵, R¹⁶, R¹⁷, and R¹⁸ (hereinafter, may be simply referred to as “R¹¹ to R¹⁸”) each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom. R¹¹ and R¹² taken together may form a ring, and so may R¹² and R¹³, and R¹³ and R¹⁴. R¹⁵ and R¹⁶ taken together may form a ring, and so may R¹⁶ and R¹⁷, and R¹⁷ and R¹⁸.

In general formula (2), R²¹, R²², R²³, R²⁴, R²⁵, R²⁶, R²⁷, and R²⁸ (hereinafter, may be simply referred to as “R²¹ to R²⁸”) each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom. R²¹ and R²² taken together may form a ring, and so may R²² and R²³, and R²³ and R²⁴. R²⁵ and R²⁶ taken together may form a ring, and so may R²⁶ and R²⁷, and R²⁷ and R²⁸.

Examples of the alkyl group represented by R¹¹ to R¹⁸ in general formula (1) include substituted or unsubstituted alkyl groups.

Examples of the unsubstituted alkyl group represented by R¹¹ to R¹⁸ in general formula (1) include linear alkyl groups having 1 to 20 carbon atoms (preferably 1 to 10 carbon atoms and more preferably 1 to 6 carbon atoms), branched alkyl groups having 3 to 20 carbon atoms (preferably 3 to 10 carbon atoms), and cyclic alkyl groups having 3 to 20 carbon atoms (preferably 3 to 10 carbon atoms).

Examples of the linear alkyl groups having 1 to 20 carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

Examples of the branched alkyl groups having 3 to 20 carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the cyclic alkyl groups having 3 to 20 carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic groups (for example, bicyclic, tricyclic, and spirocyclic groups) in which these monocyclic alkyl groups are bonded with each other.

Among those described above, linear alkyl groups, such as a methyl group and an ethyl group, are preferable as the unsubstituted alkyl group.

Examples of the substituent for the alkyl group include an alkoxy group, a hydroxyl group, a carboxy group, a nitro group, and a halogen atom (a fluorine atom, a bromine atom, and an iodine atom).

Examples of the alkoxy group substituting the hydrogen atom in the alkyl group include the same groups as the unsubstituted alkoxy groups represented by R¹¹ to R¹⁸ in general formula (1).

Examples of the alkoxy group represented by R¹¹ to R¹⁸ in general formula (1) include substituted or unsubstituted alkoxy groups.

Examples of the unsubstituted alkoxy group represented by R¹¹ to R¹⁸ in general formula (1) include linear, branched, and cyclic alkoxy groups having 1 to 10 carbon atoms (preferably 1 to 6 and more preferably 1 to 4 carbon atoms).

Specific examples of the linear alkoxy group include a methoxy group, an ethoxy group, an n-propoxy group, an n-butoxy group, an n-pentyloxy group, an n-hexyloxy group, an n-heptyloxy group, an n-octyloxy group, an n-nonyloxy group, and an n-decyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

Specific examples of the cyclic alkoxy group include a cyclopropoxy group, a cyclobutoxy group, a cyclopentyloxy group, a cyclohexyloxy group, a cycloheptyloxy group, a cyclooctyloxy group, a cyclononyloxy group, and a cyclodecyloxy group.

Among those described above, linear alkoxy groups are preferable as the unsubstituted alkoxy group.

Examples of the substituent for the alkoxy group include an aryl group, an alkoxycarbonyl group, an aryloxycarbonyl group, a hydroxyl group, a carboxy group, a nitro group, and a halogen atom (a fluorine atom, a bromine atom, and an iodine atom).

Examples of the aryl group substituting the hydrogen atom in the alkoxy group include the same groups as the unsubstituted aryl groups represented by R¹¹ to R¹⁸ in general formula (1).

Examples of the alkoxycarbonyl group substituting the hydrogen atom in the alkoxy group include the same groups as the unsubstituted alkoxycarbonyl groups represented by R¹¹ to R¹⁸ in general formula (1).

Examples of the aryloxycarbonyl group substituting the hydrogen atom in the alkoxy group include the same groups as the unsubstituted aryloxycarbonyl groups represented by R¹¹ to R¹⁸ in general formula (1).

Examples of the aralkyl group represented by R¹¹ to R¹⁸ in general formula (1) include substituted or unsubstituted aralkyl groups.

The unsubstituted aralkyl group represented by R¹¹ to R¹⁸ in general formula (1) is preferably an aralkyl group having 7 to 30 carbon atoms, more preferably an aralkyl group having 7 to 16 carbon atoms, and yet more preferably an aralkyl group having 7 to 12 carbon atoms.

Examples of the unsubstituted aralkyl group having 7 to 30 carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthratylmethyl group, and a phenyl-cyclopentylmethyl group.

Examples of the substituent for the aralkyl group include an alkoxy group, an alkoxycarbonyl group, an aryloxycarbonyl group, and a halogen atom (a fluorine atom, a bromine atom, and an iodine atom).

Examples of the alkoxy group substituting the hydrogen atom in the aralkyl group include the same groups as the unsubstituted alkoxy groups represented by R¹¹ to R¹⁸ in general formula (1).

Examples of the alkoxycarbonyl group substituting the hydrogen atom in the aralkyl group include the same groups as the unsubstituted alkoxycarbonyl groups represented by R¹¹ to R¹⁸ in general formula (1).

Examples of the aryloxycarbonyl group substituting the hydrogen atom in the aralkyl group include the same groups as the unsubstituted aryloxycarbonyl groups represented by R¹¹ to R¹⁸ in general formula (1).

Examples of the aryl group represented by R¹¹ to R¹⁸ in general formula (1) include substituted or unsubstituted aryl groups.

The unsubstituted aryl group represented by R¹¹ to R¹⁸ in general formula (1) is preferably an aryl group having 6 to 30 carbon atoms, more preferably an aryl group having 6 to 14 carbon atoms, and yet more preferably an aryl group having 6 to 10 carbon atoms.

Examples of the aryl group having 6 to 30 carbon atoms include a phenyl group, a biphenyl group, a 1-naphthyl group, a 2-naphthyl group, a 9-anthryl group, a 9-phenanthryl group, a 1-pyrenyl group, a 5-naphthacenyl group, a 1-indenyl group, a 2-azulenyl group, a 9-fluorenyl group, a biphenylenyl group, an indacenyl group, a fluoranthenyl group, an acenaphthylenyl group, an aceanthrylenyl group, a phenalenyl group, a fluorenyl group, an anthryl group, a bianthracenyl group, a teranthracenyl group, a quarter anthracenyl group, an anthraquinolyl group, a phenanthryl group, a triphenanthryl group, a pyrenyl group, a chrysenyl group, a naphthacenyl group, a pleiadenyl group, a picenyl group, a perylenyl group, a pentaphenyl group, a pentacenyl group, a tetraphenylenyl group, a hexaphenyl group, a hexacenyl group, a rubicenyl group, and a coronenyl group. Among these, a phenyl group is preferable.

Examples of the substituent for the aryl group include an alkyl group, an alkoxy group, an alkoxycarbonyl group, an aryloxycarbonyl group, and a halogen atom (a fluorine atom, a bromine atom, and an iodine atom).

Examples of the alky group substituting the hydrogen atom in the aryl group include the same groups as the unsubstituted alkyl groups represented by R¹¹ to R¹⁸ in general formula (1).

Examples of the alkoxy group substituting the hydrogen atom in the aryl group include the same groups as the unsubstituted alkoxy groups represented by R¹¹ to R¹⁸ in general formula (1).

Examples of the alkoxycarbonyl group substituting the hydrogen atom in the aryl group include the same groups as the unsubstituted alkoxycarbonyl groups represented by R¹¹ to R¹⁸ in general formula (1).

Examples of the aryloxycarbonyl group substituting the hydrogen atom in the aryl group include the same groups as the unsubstituted aryloxycarbonyl groups represented by R¹¹ to R¹⁸ in general formula (1).

Examples of the aryloxy group (—O-Ar where Ar represents an aryl group) represented by R¹¹ to R¹⁸ in general formula (1) include substituted or unsubstituted aryloxy groups.

The unsubstituted aryloxy group represented by R¹¹ to R¹⁸ in general formula (1) is preferably an aryloxy group having 6 to 30 carbon atoms, more preferably an aryloxy group having 6 to 14 carbon atoms, and yet more preferably an aryloxy group having 6 to 10 carbon atoms.

Examples of the aryloxy group having 6 to 30 carbon atoms include a phenyloxy group (phenoxy group), a biphenyloxy group, a 1-naphthyloxy group, a 2-naphthyloxy group, a 9-anthryloxy group, a 9-phenanthryloxy group, a 1-pyrenyloxy group, a 5-naphthacenyloxy group, a 1-indenyloxy group, a 2-azulenyloxy group, a 9-fluorenyloxy group, a biphenylenyloxy group, an indacenyloxy group, a fluoranthenyloxy group, an acenaphthylenyloxy group, an aceanthryleneyloxy group, a phenalenyloxy group, a fluorenyloxy group, an anthryloxy group, a bianthracenyloxy group, a teranthracenyloxy group, a quarter anthracenyloxy group, an anthraquinolyloxy group, a phenanthryloxy group, a triphenylenyloxy group, a pyrenyloxy group, a chrycenyloxy group, a naphthacenyloxy group, a pleiadenyloxy group, a picenyloxy group, a peryleneyloxy group, a pentaphenyloxy group, a pentacenyloxy group, a tetraphenylenyloxy group, a hexaphenyloxy group, a hexacenyloxy group, a rubicenyloxy group, and coronenyloxy group. Among these, a phenyloxy group (phenoxy group) is preferable.

Examples of the substituent for the aryloxy group include an alkyl group, an alkoxycarbonyl group, an aryloxycarbonyl group, and a halogen atom (a fluorine atom, a bromine atom, and an iodine atom).

Examples of the alky group substituting the hydrogen atom in the aryloxy group include the same groups as the unsubstituted alkyl groups represented by R¹¹ to R¹⁸ in general formula (1).

Examples of the alkoxycarbonyl group substituting the hydrogen atom in the aryloxy group include the same groups as the unsubstituted alkoxycarbonyl groups represented by R¹¹ to R¹⁸ in general formula (1).

Examples of the aryloxycarbonyl group substituting the hydrogen atom in the aryloxy group include the same groups as the unsubstituted aryloxycarbonyl groups represented by R¹¹ to R¹⁸ in general formula (1).

Examples of the alkoxycarbonyl group (—CO—OR where R represents an alkyl group) represented by R¹¹ to R¹⁸ in general formula (1) include substituted or unsubstituted alkoxycarbonyl groups.

The number of carbon atoms in the alkyl chain in the unsubstituted alkoxycarbonyl group represented by R¹¹ to R¹⁸ in general formula (1) is preferably 1 to 20, more preferably 1 to 15, and yet more preferably 1 to 10.

Examples of the alkoxycarbonyl group having 1 to 20 carbon atoms in the alkyl chain include a methoxycarbonyl group, an ethoxycarbonyl group, a propoxycarbonyl group, an isopropoxycarbonyl group, an n-butoxycarbonyl group, a sec-butoxybutylcarbonyl group, a tert-butoxycarbonyl group, a pentaoxycarbonyl group, a hexaoxycarbonyl group, a heptaoxycarbonyl group, an octaoxycarbonyl group, a nonaoxycarbonyl group, a decaoxycarbonyl group, a dodecaoxycarbonyl group, a tridecaoxycarbonyl group, a tetradecaoxycarbonyl group, a pentadecaoxycarbonyl group, a hexadecaoxycarbonyl group, a heptadecaoxycarbonyl group, an octadecaoxycarbonyl group, a nonadecaoxycarbonyl group, and an icosaoxycarbonyl group.

Examples of the substituent for the alkoxycarbonyl group include an aryl group, a hydroxyl group, and a halogen atom (a fluorine atom, a bromine atom, and an iodine atom).

Examples of the aryl group substituting the hydrogen atom in the alkoxycarbonyl group include the same groups as the unsubstituted aryl groups represented by R¹¹ to R¹⁸ in general formula (1).

Examples of the aryloxycarbonyl group (—CO—OAr where Ar represents an aryl group) represented by R¹¹ to R¹⁸ in general formula (1) include substituted or unsubstituted aryloxycarbonyl groups.

The number of carbon atoms in the aryl group in the unsubstituted aryloxycarbonyl group represented by R¹¹ to R¹⁸ in general formula (1) is preferably 6 to 30, more preferably 6 to 14, and yet more preferably 6 to 10.

Examples of the aryloxycarbonyl group having an aryl group having 6 to 30 carbon atoms include a phenoxycarbonyl group, a biphenyloxycarbonyl group, a 1-naphthyloxycarbonyl group, a 2-naphthyloxycarbonyl group, a 9-anthryloxycarbonyl group, a 9-phenanthryloxycarbonyl group, a 1-pyrenyloxycarbonyl group, a 5-naphthacenyloxycarbonyl group, a 1-indenyloxycarbonyl group, a 2-azulenyloxycarbonyl group, a 9-fluorenyloxycarbonyl group, a biphenylenyloxycarbonyl group, an indacenyloxycarbonyl group, a fluoranthenyloxycarbonyl group, an acenaphthylenyloxycarbonyl group, an aceanthryleneyloxycarbonyl group, a phenalenyloxycarbonyl group, a fluorenyloxycarbonyl group, an anthryloxycarbonyl group, a bianthracenyloxycarbonyl group, a teranthracenyloxycarbonyl group, a quarter anthracenyloxycarbonyl group, an anthraquinolyloxycarbonyl group, a phenanthryloxycarbonyl group, a triphenylenyloxycarbonyl group, a pyrenyloxycarbonyl group, a chrycenyloxycarbonyl group, a naphthacenyloxycarbonyl group, a pleiadenyloxycarbonyl group, a picenyloxycarbonyl group, a peryleneyloxycarbonyl group, a pentaphenyloxycarbonyl group, a pentacenyloxycarbonyl group, a tetraphenylenyloxycarbonyl group, a hexaphenyloxycarbonyl group, a hexacenyloxycarbonyl group, a rubicenyloxycarbonyl group, and a coronenyloxycarbonyl group. Among these, a phenoxycarbonyl group is preferable.

Examples of the substituent for the aryloxycarbonyl group include an alkyl group, a hydroxyl group, and a halogen atom (a fluorine atom, a bromine atom, and an iodine atom).

Examples of the alky group substituting the hydrogen atom in the aryloxycarbonyl group include the same groups as the unsubstituted alkyl groups represented by R¹¹ to R¹⁸ in general formula (1).

Examples of the alkoxycarbonylalkyl group (—(CₙH₂ₙ)—CO—OR where R represents an alkyl group, and n represents an integer of 1 or more) represented by R¹¹ to R¹⁸ in general formula (1) include substituted or unsubstituted alkoxycarbonylalkyl groups.

Examples of the alkoxycarbonyl group (—CO—OR) in the unsubstituted alkoxycarbonylalkyl group represented by R¹¹ to R¹⁸ in general formula (1) include the same groups as the alkoxycarbonylalkyl groups represented by R¹¹ to R¹⁸ in general formula (1).

Examples of the alkylene chain (—CₙH₂ₙ—) in the unsubstituted alkoxycarbonylalkyl group by R¹¹ to R¹⁸ in general formula (1) include linear alkylene chains having 1 to 20 carbon atoms (preferably 1 to 10 carbon atoms and more preferably 1 to 6 carbon atoms), branched alkylene chains having 3 to 20 carbon atoms (preferably 3 to 10 carbon atoms), and cyclic alkylene chains having 3 to 20 carbon atoms (preferably 3 to 10 carbon atoms).

Examples of the linear alkylene chains having 1 to 20 carbon atoms include a methylene group, an ethylene group, an n-propylene group, an n-butylene group, an n-pentylene group, an n-hexylene group, an n-heptylene group, an n-octylene group, an n-nonylene group, an n-decylene group, an n-undecylene group, an n-dodecylene group, a tridecylene group, an n-tetradecylene group, an n-pentadecylene group, an n-heptadecylene group, an n-octadecylene group, an n-nonadecyl group, and an n-icosylene group.

Examples of the branched alkylene chains having 3 to 20 carbon atoms include an isopropylene group, an isobutylene group, a sec-butylene group, a tert-butylene group, an isopentylene group, a neopentylene group, a tert-pentylene group, an isohexylene group, a sec-hexylene group, a tert-hexylene group, an isoheptylene group, a sec-heptylene group, a tert-heptylene group, an isooctylene group, a sec-octylene group, a tert-octylene group, an isononylene group, a sec-nonylene group, a tert-nonylene group, an isodecylene group, a sec-decylene group, a tert-decylene group, an isododecylene group, a sec-dodecylene group, a tert-dodecylene group, a tert-tetradecylene group, and a tert-pentadecylene group.

Examples of the cyclic alkylene chains having 3 to 20 carbon atoms include a cyclopropylene group, a cyclobutylene group, a cyclopentylene group, a cyclohexylene group, a cycloheptylene group, a cyclooctylene group, a cyclononylene group, and a cyclodecylene group.

Examples of the substituent for the alkoxycarbonylalkyl group include an aryl group, a hydroxyl group, and a halogen atom (a fluorine atom, a bromine atom, and an iodine atom).

Examples of the aryl group substituting the hydrogen atom in the alkoxycarbonylalkyl group include the same groups as the unsubstituted aryl groups represented by R¹¹ to R¹⁸ in general formula (1).

Examples of the aryloxycarbonylalkyl group (—(CₙH₂ₙ)—CO—OAr where Ar represents an aryl group, and n represents an integer of 1 or more) represented by R¹¹ to R¹⁸ in general formula (1) include substituted or unsubstituted aryloxycarbonylalkyl groups.

Examples of the aryloxycarbonyl group (—CO—OAr where Ar represents an aryl group) in the unsubstituted aryloxycarbonylalkyl group represented by R¹¹ to R¹⁸ in general formula (1) include the same groups as the aryloxycarbonyl groups represented by R¹¹ to R¹⁸ in general formula (1).

Examples of the alkylene chain (—CₙH₂ₙ—) in the unsubstituted aryloxycarbonylalkyl group represented by R¹¹ to R¹⁸ in general formula (1) include the same groups as the alkylene chains in the alkoxycarbonylalkyl groups represented by R¹¹ to R¹⁸ in general formula (1).

Examples of the substituent for the aryloxycarbonylalkyl group include an alkyl group, a hydroxyl group, and a halogen atom (a fluorine atom, a bromine atom, and an iodine atom).

Examples of the alky group substituting the hydrogen atom in the aryloxycarbonylalkyl group include the same groups as the unsubstituted alkyl groups represented by R¹¹ to R¹⁸ in general formula (1).

Examples of the halogen atom represented by R¹¹ to R¹⁸ in general formula (1) include a fluorine atom, a chlorine atom, a bromine atom, and an iodine atom.

Examples of the cyclic structure formed by bonding between R¹¹ and R¹², R¹² and R¹³, R¹³ and R¹⁴, R¹⁵ and R¹⁶, R¹⁶ and R¹⁷ or R¹⁷ and R¹⁸ in general formula (1) include a benzene ring, a fused ring having 10 to 18 carbon atoms (a naphthalene ring, an anthracene ring, a phenanthrene ring, a chrysene ring (a benzo[α]phenanthrene ring), a tetracene ring, a tetraphene ring (benzo[α]anthracene ring), and a triphenylene ring). Among these, a benzene ring is preferable as the cyclic structure to be formed.

Examples of the alkyl group represented by R²¹ to R²⁸ in general formula (2) include the same groups as the alkyl groups represented by R¹¹ to R¹⁸ in general formula (1).

Examples of the alkoxy group represented by R²¹ to R²⁸ in general formula (2) include the same groups as the alkoxy groups represented by R¹¹ to R¹⁸ in general formula (1).

Examples of the aralkyl group represented by R²¹ to R²⁸ in general formula (2) include the same groups as the aralkyl groups represented by R¹¹ to R¹⁸ in general formula (1).

Examples of the aryl group represented by R²¹ to R²⁸ in general formula (2) include the same groups as the aryl groups represented by R¹¹ to R¹⁸ in general formula (1).

Examples of the aryloxy group represented by R²¹ to R²⁸ in general formula (2) include the same groups as the aryloxy groups represented by R¹¹ to R¹⁸ in general formula (1).

Examples of the alkoxycarbonyl group represented by R²¹ to R²⁸ in general formula (2) include the same groups as the alkoxycarbonyl groups represented by R¹¹ to R¹⁸ in general formula (1).

Examples of the aryloxycarbonyl group represented by R²¹ to R²⁸ in general formula (2) include the same groups as the aryloxycarbonyl groups represented by R¹¹ to R¹⁸ in general formula (1).

Examples of the alkoxycarbonylalkyl group represented by R²¹ to R²⁸ in general formula (2) include the same groups as the alkoxycarbonylalkyl groups represented by R¹¹ to R¹⁸ in general formula (1).

Examples of the aryloxycarbonylalkyl group represented by R²¹ to R²⁸ in general formula (2) include the same groups as the aryloxycarbonylalkyl groups represented by R¹¹ to R¹⁸ in general formula (1).

Examples of the halogen atom represented by R²¹ to R²⁸ in general formula (2) include the same atoms as the halogen atoms represented by R¹¹ to R¹⁸ in general formula (1).

Examples of the cyclic structure formed by linking between R²¹ and R²², R²² and R²³, R²³ and R²⁴, R²⁵ and R²⁶, R²⁶ and R²⁷, or R²⁷ and R²⁸ in general formula (2) include a benzene ring, a fused ring having 10 to 18 carbon atoms (a naphthalene ring, an anthracene ring, a phenanthrene ring, a chrysene ring (a benzo[α]phenanthrene ring), a tetracene ring, a tetraphene ring (benzo[α]anthracene ring), and a triphenylene ring). Among these, a benzene ring is preferable as the cyclic structure to be formed.

In general formula (1), R¹¹, R¹², R¹³, R¹⁴, R¹⁵, R¹⁶, R¹⁷, and R¹⁸ may each independently represent a hydrogen atom, an alkyl group, an alkoxycarbonyl group, an aryloxycarbonyl group, an alkoxycarbonylalkyl group, or an aryloxycarbonylalkyl group.

In general formula (2), R²¹, R²², R²³, R²⁴, R²⁵, R²⁶, R²⁷, and R²⁸ may each independently represent a hydrogen atom, an alkyl group, an alkoxycarbonyl group, an aryloxycarbonyl group, an alkoxycarbonylalkyl group, or an aryloxycarbonylalkyl group.

In the description below, specific examples of the compounds represented by general formula (1) or (2) are described, and these examples are not limiting.

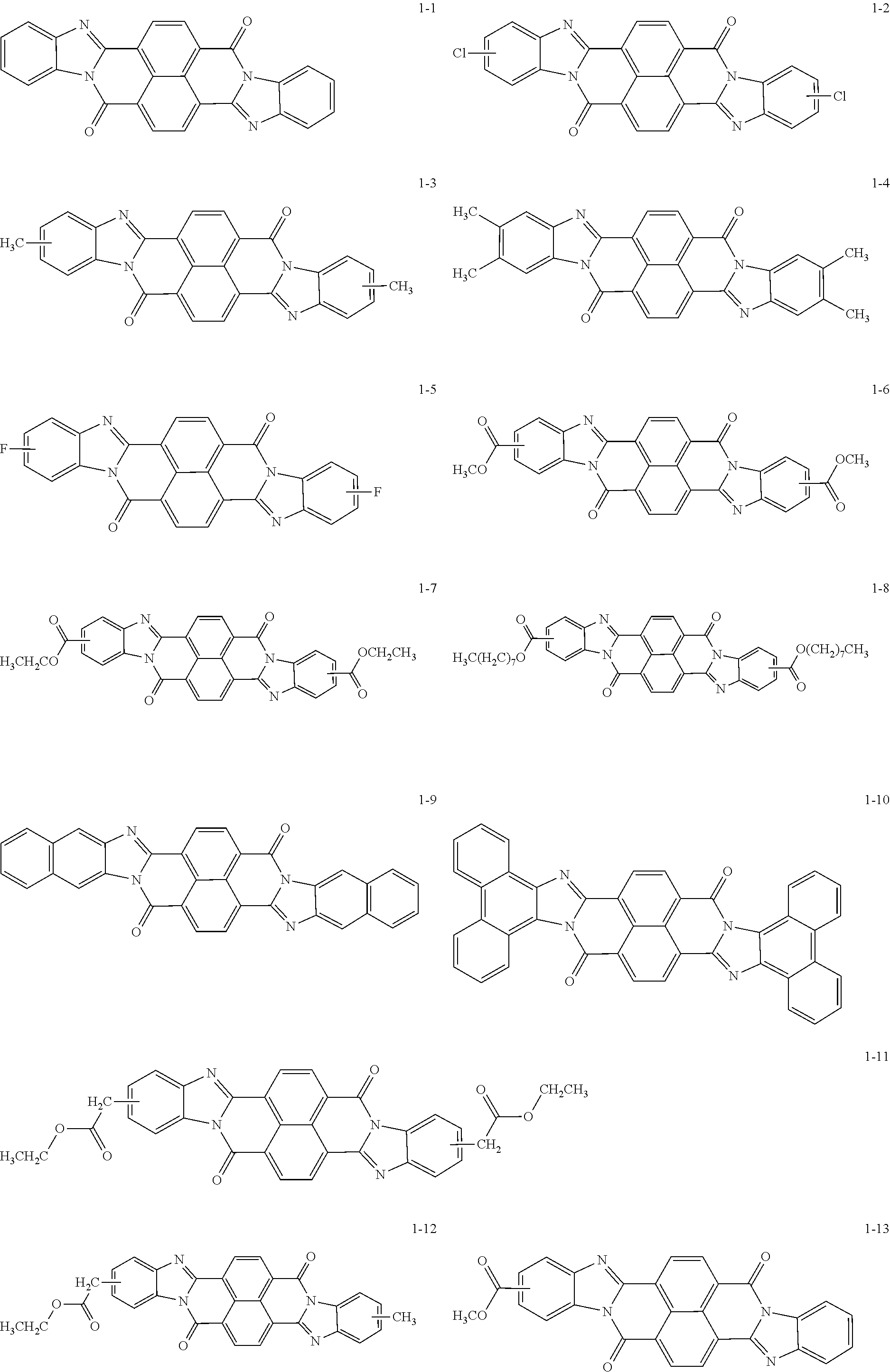

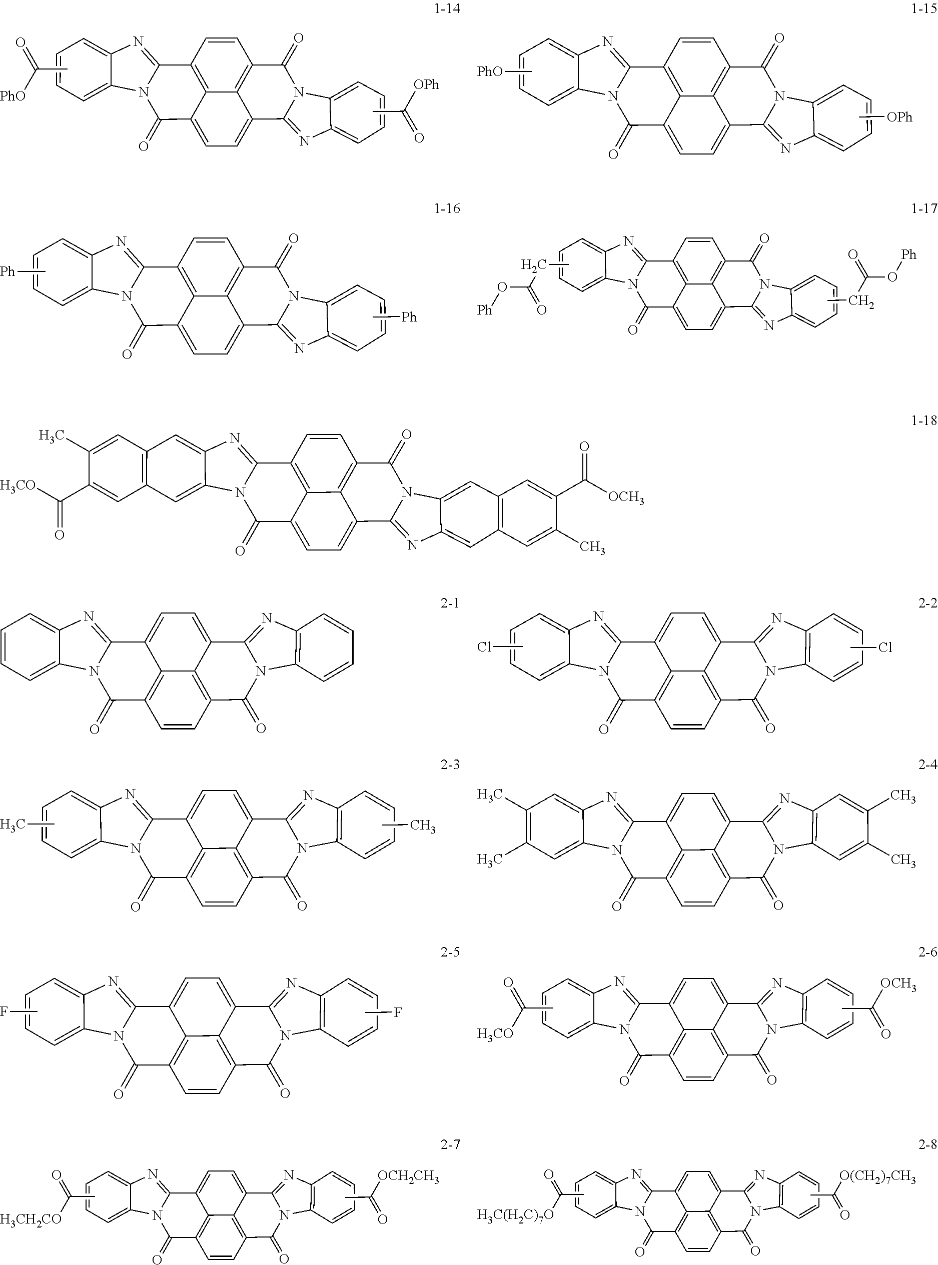

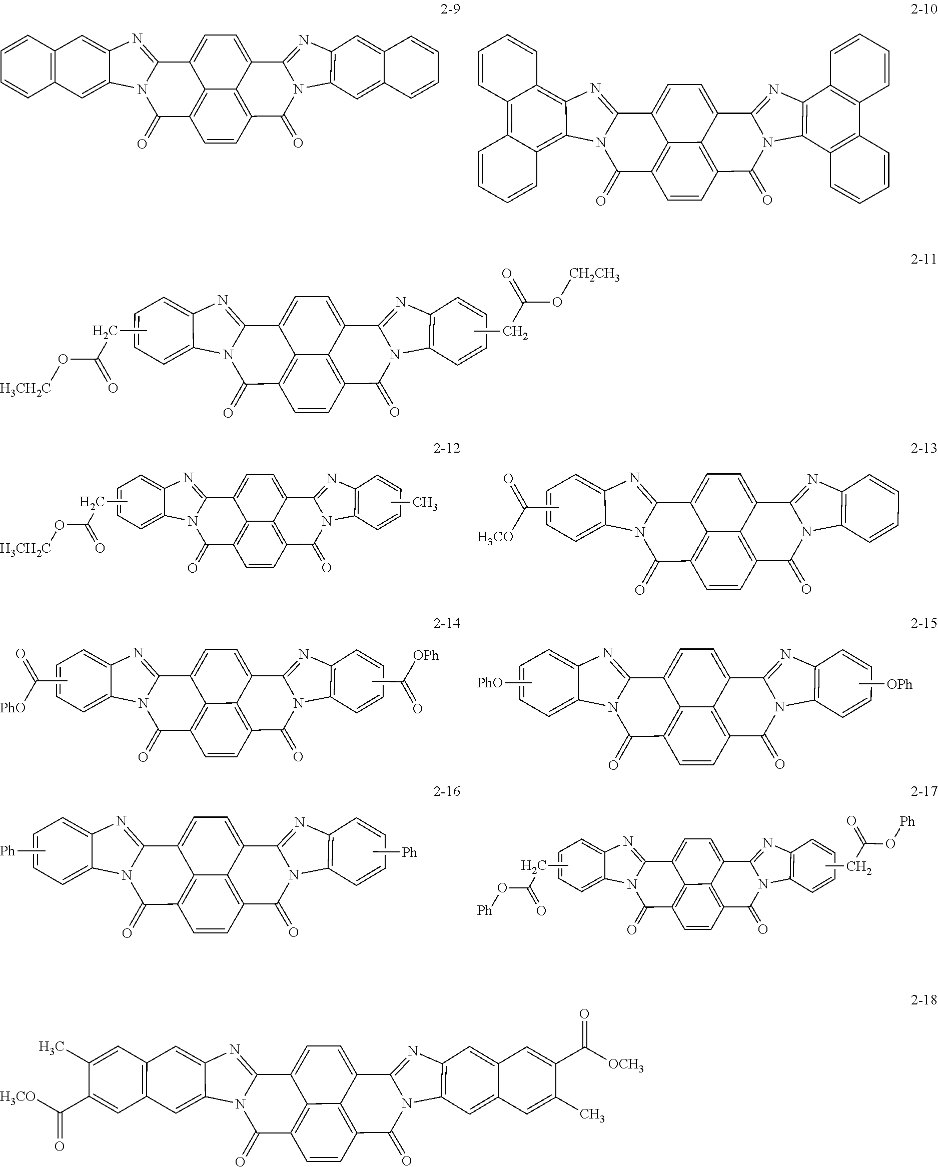

A compound represented by general formula (1) and a compound represented by general formula (2) are isomeric to each other (in other words, a cis isomer and a trans isomer). A typical synthetic scheme involves heating and fusing 2 mol of an orthophenylenediamine compound and 1 mol of a naphthalenetetracarboxylic acid compound, which gives a mixture of cis and trans isomers, and the mix ratio is usually larger for the cis isomer than the trans isomer. Separating the cis isomer and the trans isomer can involve, for example, heating and washing with an alcohol solution of potassium hydroxide so that the cis isomer soluble in the solution can be separated from the trans isomer that is insoluble in the solution.

### Compounds Represented by General Formula (3)

Compounds represented by general formula (3) will now be described.

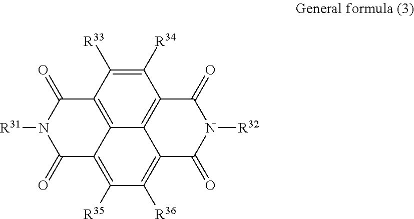

In general formula (3), R³¹, R³², R³³, R³⁴, R³⁵, and R³⁶ (hereinafter may be simply referred to as R³¹ to R³⁶) each independently represent a hydrogen atom, an alkyl group, an alkoxy group, an aralkyl group, an aryl group, an alkoxycarbonyl group, or a halogen atom.

Examples of the alkyl group, the alkoxy group, the aralkyl group, the aryl group, the alkoxycarbonyl group, and the halogen atom represented by R³¹ to R³⁶ in general formula (3) include the same groups and atoms as the alkyl groups, the alkoxy groups, the aralkyl groups, the aryl groups, the alkoxycarbonyl groups, and the halogen atoms represented by R¹¹ to R¹⁸ in general formula (1).

The alkyl group, the alkoxy group, the aralkyl group, the aryl group, and the alkoxycarbonyl group represented by R³¹ to R³⁶ in general formula (3) may each have a substituent the same as the substituent for the alkyl group, the alkoxy group, the aralkyl group, the aryl group, and the alkoxycarbonyl group represented by R¹¹ to R¹⁸ in general formula (1).

In the description below, example compounds of the compounds represented by general formula (3) are described, and these examples are not limiting. Note that an example compound number below is hereinafter indicated as an example compound (3-number). Specifically, for example, an example compound 5 is referred to as an “example compound (3-5).

| Example | | | | | | |
|---|---|---|---|---|---|---|
| compound | R³¹ | R³² | R³³ | R³⁴ | R³⁵ | R³⁶ |
| 1 | H | H | H | H | H | H |
| 2 | —CH₃ | —CH₃ | H | H | H | H |
| 3 | —Pr | —Pr | H | H | H | H |
| 4 | —CH₂COOCH₃ | —CH₂COOCH₃ | H | H | H | H |
| 5 | -c-C₆H₁₁ | -c-C₆H₁₁ | H | H | H | H |
| 6 | -c-C₆H₁₁ | -c-C₆H₁₁ | —Br | H | H | —Br |
| 7 | —C₆H₅ | —C₆H₅ | H | H | H | H |
| 8 | -p-Cl—C₆H₄ | -p-Cl—C₆H₄ | H | H | H | H |
| 9 | —CH₂C₆H₅ | —CH₂C₆H₅ | H | H | H | H |
| 10 | —CH₂CH₂C₆H₅ | —CH₂CH₂C₆H₅ | H | H | H | H |

Abbreviations in the aforementioned example compounds are as follows.
Pr: n-propyl group
c-C₆H₁₁: cyclohexyl group
C₆H₅: phenyl group
p-Cl—C₆H₄: parachlorophenyl group
CH₂C₆H₅: benzyl group
CH₂CH₂C₆H₅: phenethyl group

### Compounds Represented by General Formula (4)

Compounds represented by general formula (4) will now be described.

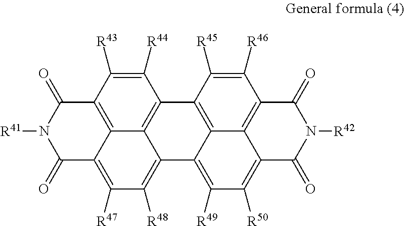

In general formula (4), R⁴¹, R⁴², R⁴³, R⁴⁴, R⁴⁵, R⁴⁶, R⁴⁷, R⁴⁸, R⁴⁹, and R⁵⁰ (hereinafter may be simply referred to as “R⁴¹ to R⁵⁰”) each independently represent a hydrogen atom, an alkyl group, an alkoxy group, an aralkyl group, an aryl group, an alkoxycarbonyl group, or a halogen atom.

Examples of the alkyl group, the alkoxy group, the aralkyl group, the aryl group, the alkoxycarbonyl group, and the halogen atom represented by R⁴¹ to R⁵⁰ in general formula (4) include the same groups and atoms as the alkyl groups, the alkoxy groups, the aralkyl groups, the aryl groups, the alkoxycarbonyl groups, and the halogen atoms represented by R¹¹ to R¹⁸ in general formula (1).

The alkyl group, the alkoxy group, the aralkyl group, the aryl group, and the alkoxycarbonyl group represented by R⁴¹ to R⁵⁰ in general formula (4) may each have a substituent the same as the substituent for the alkyl group, the alkoxy group, the aralkyl group, the aryl group, and the alkoxycarbonyl group represented by R¹¹ to R¹⁸ in general formula (1).

In the description below, example compounds of the compounds represented by general formula (4) are described, and these examples are not limiting. Note that an example compound number below is hereinafter indicated as an example compound (4-number). Specifically, for example, an example compound 5 is referred to as an “example compound (4-5).

| Example | | | | | | | | | | |
|---|---|---|---|---|---|---|---|---|---|---|
| compound | R⁴¹ | R⁴² | R⁴³ | R⁴⁴ | R⁴⁵ | R⁴⁶ | R⁴⁷ | R⁴⁸ | R⁴⁹ | R⁵⁰ |
| 1 | H | H | H | H | H | H | H | H | H | H |
| 2 | —CH₃ | —CH₃ | H | H | H | H | H | H | H | H |
| 3 | —CH₃ | —CH₃ | H | —Cl | —Cl | H | H | —Cl | —Cl | H |
| 4 | —Bu | —Bu | H | F | H | H | H | H | F | H |
| 5 | -c-C₆H₁₁ | -c-C₆H₁₁ | H | H | H | H | H | H | H | H |
| 6 | -p-CH₃—C₆—H₄ | -p-CH₃—C₆—H₅ | H | H | H | H | H | H | H | H |
| 7 | —C₆H₅ | —C₆H₅ | H | H | H | H | H | H | H | H |
| 8 | -p-Cl—C₆H₄ | -p-Cl—C₆H₄ | H | H | H | H | H | H | H | H |
| 9 | -o-Cl—C₆H₄ | -o-Cl—C₆H₄ | H | H | H | H | H | H | H | H |
| 10 | —CH₂C₆H₅ | —CH₂C₆H₅ | H | H | H | H | H | H | H | H |
| 11 | -3,5-(CH₃)₂—C₆H₃ | -3,5-(CH₃)₂—C₆H₃ | H | H | H | H | H | H | H | H |
| 12 | -3,5-Cl₂—C₆H₃ | -3,5-Cl₂—C₆H₃ | H | H | H | H | H | H | H | H |

Abbreviations in the aforementioned example compounds are as follows.
Bu: n-butyl group
c-C₆H₁₁: cyclohexyl group
p-CH₃—C₆H₄: paratolyl group
C₆H₅: phenyl group
p-Cl—C₆H₄: parachlorophenyl group
o-Cl—C₆H₄: orthochlorophenyl group
CH₂C₆H₅: benzyl group
3,5-(CH₃)₂—C₆H₃: 3,5-dimethylphenyl group
3,5-Cl₂-C₆H₃: 3,5-dichlorophenyl group

### Compounds Represented by General Formula (5)

Compounds represented by general formula (5) will now be described.

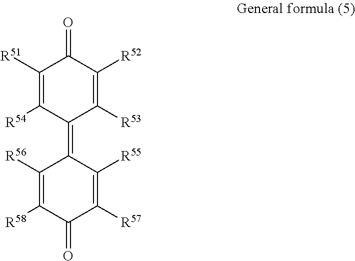

In general formula (5), R⁵¹, R⁵², R⁵³, R⁵⁴, R⁵⁵, R⁵⁶, R⁵⁷, and R⁵⁸ (hereinafter may be simply referred to as “R⁵¹ to R⁵⁸”) each independently represent a hydrogen atom, an alkyl group, an alkoxy group, an aralkyl group, an aryl group, an alkoxycarbonyl group, or a halogen atom.

Examples of the alkyl group, the alkoxy group, the aralkyl group, the aryl group, the alkoxycarbonyl group, and the halogen atom represented by R⁵¹ to R⁵⁸ in general formula (5) include the same groups and atoms as the alkyl groups, the alkoxy groups, the aralkyl groups, the aryl groups, the alkoxycarbonyl groups, and the halogen atoms represented by R¹¹ to R¹⁸ in general formula (1).

The alkyl group, the alkoxy group, the aralkyl group, the aryl group, and the alkoxycarbonyl group represented by R⁵¹ to R⁵⁸ in general formula (5) may each have a substituent the same as the substituent for the alkyl group, the alkoxy group, the aralkyl group, the aryl group, and the alkoxycarbonyl group represented by R¹¹ to R¹⁸ in general formula (1).

In general formula (5), R⁵¹ to R⁵⁸ may each independently represent a hydrogen atom, an alkyl group having 1 to 12 carbon atoms, an alkoxy group having 1 to 12 carbon atoms, a cycloalkyl group, an aryl group, or an aralkyl group.

From the viewpoint of further reducing the residual potential, R⁵¹ and R⁵⁸ in general formula (5) preferably each independently represent an alkyl group having 3 to 12 carbon atoms, an alkoxy group having 3 to 12 carbon atoms, a cycloalkyl group, an aryl group, or an aralkyl group, more preferably each independently represent a branched alkyl group having 3 to 12 carbon atoms, a branched alkoxy group having 3 to 12 carbon atoms, a cycloalkyl group, an aryl group, or an aralkyl group, yet more preferably each independently represent a branched alkyl having 3 to 8 carbon atoms or a branched alkoxy group having 3 to 8 carbon atoms, and particularly preferably each independently represent a t-butyl group.

From the viewpoint of further reducing the residual potential, R⁵² and R⁵⁷ in general formula (5) preferably each independently represent a hydrogen atom, an alkyl group having 1 to 8 carbon atoms, or an alkoxy group having 1 to 8 carbon atoms, more preferably each independently represent a hydrogen atom, a linear alkyl group having 1 to 4 carbon atoms, or a linear alkoxy group having 1 to 4 carbon atoms, yet more preferably each independently represent a linear alkyl group having 1 to 3 carbon atoms or a linear alkoxy group having 1 to 3 carbon atoms, and particularly preferably each independently represent a methyl group.

In general formula (5), R⁵³, R⁵⁴, R⁵⁵, and R⁵⁶ may represent a hydrogen atom.

In general formula (5), R⁵¹ and R⁵⁸ may be the same group from the viewpoint of further reducing the residual potential.

In general formula (5), R⁵² and R⁵⁷ may be the same group from the viewpoint of further reducing the residual potential.

In general formula (5), R⁵¹ and R⁵² may be different groups from the viewpoint of further reducing the residual potential.

In general formula (5), R⁵⁷ and R⁵⁸ may be different groups from the viewpoint of further reducing the residual potential.

In the description below, example compounds of the compounds represented by general formula (5) are described, and these examples are not limiting. Note that an example compound number below is hereinafter indicated as an example compound (5-number). Specifically, for example, an example compound 5 is referred to as an “example compound (5-5).

| Example | | | | | | | | |
|---|---|---|---|---|---|---|---|---|
| compound | R⁵¹ | R⁵² | R⁵³ | R⁵⁴ | R⁵⁵ | R⁵⁶ | R⁵⁷ | R⁵⁸ |
| 1 | -t-C₄H₉ | —CH₃ | H | H | H | H | —CH₃ | -t-C₄H₉ |
| 2 | -t-C₄H₉ | H | H | H | H | H | H | -t-C₄H₉ |
| 3 | -t-C₄H₉ | —OCH₃ | H | H | H | H | —OCH₃ | -t-C₄H₉ |
| 4 | -t-C₄H₉O | —CH₃ | H | H | H | H | —CH₃ | -t-C₄H₉O |
| 5 | -c-C₆H₁₁ | —CH₃ | H | H | H | H | —CH₃ | -c-C₆H₁₁ |
| 6 | —C₆H₅ | —CH₃ | H | H | H | H | —CH₃ | —C₆H₅ |
| 7 | —CH₂C₆H₅ | —CH₃ | H | H | H | H | —CH₃ | —CH₂C₆H₅ |
| 8 | -t-C₄H₉ | -t-C₄H₉ | H | H | H | H | -t-C₄H₉ | -t-C₄H₉ |

Abbreviations in the aforementioned example compounds are as follows.
t-C₄H₉: t-butyl group
OCH₃: methoxy group
t-C₄H₉O: t-butoxy group
c-C₆H₁₁: cyclohexyl group
C₆H₅: phenyl group
CH₂C₆H₅: benzyl group

### Compounds Represented by General Formula (6)

Compounds represented by general formula (6) will now be described.

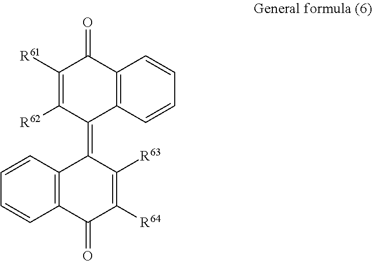

In general formula (6), R⁶¹, R⁶², R⁶³, and R⁶⁴ (hereinafter may be simply referred to as R⁶¹ to R⁶⁴) each independently represent a hydrogen atom, an alkyl group, an alkoxy group, an aralkyl group, an aryl group, an alkoxycarbonyl group, or a halogen atom.

Examples of the alkyl group, the alkoxy group, the aralkyl group, the aryl group, the alkoxycarbonyl group, and the halogen atom represented by R⁶¹ to R⁶⁴ in general formula (6) include the same groups and atoms as the alkyl groups, the alkoxy groups, the aralkyl groups, the aryl groups, the alkoxycarbonyl groups, and the halogen atoms represented by R¹¹ to R¹⁸ in general formula (1).

The alkyl group, the alkoxy group, the aralkyl group, the aryl group, and the alkoxycarbonyl group represented by R⁶¹ to R⁶⁴ in general formula (6) may each have a substituent the same as the substituent for the alkyl group, the alkoxy group, the aralkyl group, the aryl group, and the alkoxycarbonyl group represented by R¹¹ to R¹⁸ in general formula (1).

In general formula (6), R⁶¹ to R⁶⁴ may each independently represent a hydrogen atom, an alkyl group having 1 to 12 carbon atoms, an alkoxy group having 1 to 12 carbon atoms, a cycloalkyl group, an aryl group, or an aralkyl group.

From the viewpoint of further reducing the residual potential, R⁶¹ and R⁶⁴ in general formula (6) preferably each independently represent an alkyl group having 3 to 12 carbon atoms, an alkoxy group having 3 to 12 carbon atoms, a cycloalkyl group, an aryl group, or an aralkyl group, more preferably each independently represent a branched alkyl group having 3 to 12 carbon atoms, a branched alkoxy group having 3 to 12 carbon atoms, a cycloalkyl group, an aryl group, or an aralkyl group, yet more preferably each independently represent a branched alkyl having 3 to 8 carbon atoms or a branched alkoxy group having 3 to 8 carbon atoms, and particularly preferably each independently represent a t-butyl group.

From the viewpoint of further reducing the residual potential, R⁶² and R⁶⁴ in general formula (6) preferably each independently represent a hydrogen atom, an alkyl group having 1 to 8 carbon atoms, or an alkoxy group having 1 to 8 carbon atoms, more preferably each independently represent a hydrogen atom, a linear alkyl group having 1 to 4 carbon atoms, or a linear alkoxy group having 1 to 4 carbon atoms, yet more preferably each independently represent a linear alkyl group having 1 to 3 carbon atoms or a linear alkoxy group having 1 to 3 carbon atoms, and particularly preferably each independently represent a methyl group.

In general formula (6), R⁶¹ and R⁶⁴ may be the same group.

In general formula (6), R⁶² and R⁶³ may be the same group.

In general formula (6), R⁶¹ and R⁶² may be different groups.

In general formula (6), R⁶³ and R⁶⁴ may be different groups.

In the description below, example compounds of the compounds represented by general formula (6) are described, and these examples are not limiting. Note that an example compound number below is hereinafter indicated as an example compound (6-number). Specifically, for example, an example compound 5 is referred to as an “example compound (6-5).

| Example compound | R⁶¹ | R⁶² | R⁶³ | R⁶⁴ |
|---|---|---|---|---|
| 1 | -t-C₄H₉ | —CH₃ | —CH₃ | -t-C₄H₉ |
| 2 | -t-C₄H₉ | H | H | -t-C₄H₉ |
| 3 | -t-C₄H₉ | —OCH₃ | —OCH₃ | -t-C₄H₉ |
| 4 | -t-C₄H₉O | —CH₃ | —CH₃ | -t-C₄H₉O |
| 5 | -c-C₆H₁₁ | —CH₃ | —CH₃ | -c-C₆H₁₁ |
| 6 | —C₆H₅ | —CH₃ | —CH₃ | —C₆H₅ |
| 7 | —CH₂C₆H₅ | —CH₃ | —CH₃ | —CH₂C₆H₅ |

Abbreviations in the aforementioned example compounds are as follows.
t-C₄H₉: t-butyl group
OCH₃: methoxy group
t-C₄H₉O: t-butoxy group
c-C₆H₁₁: cyclohexyl group
C₆H₅: phenyl group
CH₂C₆H₅: benzyl group

### Compounds Represented by General Formula (7)

Compounds represented by general formula (7) will now be described.

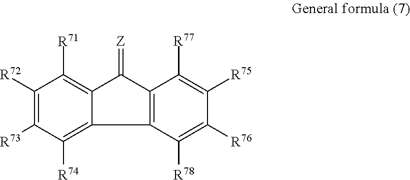

In general formula (7), R⁷¹, R⁷², R⁷³, R⁷⁴, R⁷⁵, R⁷⁶, R⁷⁷, and R⁷⁸ (hereinafter may be simply referred to as “R⁷¹ to R⁷⁸”) each independently represent a hydrogen atom, an alkyl group, an alkoxy group, an aralkyl group, an aryl group, an acyl group, an alkoxycarbonyl group, or a halogen atom, and Z represents an oxygen atom or a dicyanomethylene group (═C(CN)₂).

Examples of the alkyl group represented by R⁷¹ to R⁷⁸ in general formula (7) include linear or branched alkyl groups having 1 to 4 carbon atoms (preferably 1 to 3 carbon atoms), specifically, a methyl group, an ethyl group, an n-propyl group, an isopropyl group, an n-butyl group, and an isobutyl group.

Examples of the alkoxy group represented by R⁷¹ to R⁷⁸ in general formula (7) include alkoxy groups having 1 to 4 carbon atoms (preferably 1 to 3 carbon atoms), specifically, a methoxy group, an ethoxy group, a propoxy group, and a butoxy group.

Examples of the aralkyl group represented by R⁷¹ to R⁷⁸ in general formula (7) include groups represented by -L-Ar, where L represents an alkylene group and Ar represents an aryl group.

Examples of the alkylene group represented by L include linear or branched alkylene groups having 1 to 12 carbon atoms, specifically, a methylene group, an ethylene group, an n-propylene group, an isopropylene group, an n-butylene group, an isobutylene group, a sec-butylene group, a tert-butylene group, an n-pentylene group, an isopentylene group, a neopentylene group, and a tert-pentylene group.

Examples of the aryl group represented by Ar include a phenyl group, a methylphenyl group, a dimethylphenyl group, and an ethylphenyl group.

Specific examples of the aralkyl group represented by R⁷¹ to R⁷⁸ in general formula (7) include a benzyl group, a methylbenzyl group, a dimethylbenzyl group, a phenylethyl group, a methylphenylethyl group, a phenylpropyl group, and a phenylbutyl group.

Examples of the aryl group represented by R⁷¹ to R⁷⁸ in general formula (7) include a phenyl group, a methylphenyl group, a dimethylphenyl group, and an ethylphenyl group. Among these, a phenyl group is preferable.

Examples of the acyl group (—C(═O)—R^{AC} where R^{AC} represents a hydrocarbon group) represented by R⁷¹ to R⁷⁸ in general formula (7) include acyl groups having 1 to 10 carbon atoms (preferably 1 to 6 carbon atoms and more preferably 1 to 3 carbon atoms), specifically, an acetyl group, a propanoyl group, a benzoyl group, and a cyclohexanecarbonyl group.

Examples of the alkoxycarbonyl group represented by R⁷¹ to R⁷⁸ in general formula (7) include the same groups as the alkoxycarbonyl groups represented by R¹¹ to R¹⁸ in general formula (1).

The alkyl group, the alkoxy group, the aralkyl group, the aryl group, and the alkoxycarbonyl group represented by R⁷¹ to R⁷⁸ in general formula (7) may each have a substituent the same as the substituent for the alkyl group, the alkoxy group, the aralkyl group, the aryl group, and the alkoxycarbonyl group represented by R¹¹ to R¹⁸ in general formula (1).

The acyl group represented by R⁷¹ to R⁷⁸ in general formula (7) may have a substituent the same as the substituent for the alkyl group represented by R¹¹ to R¹⁸ in general formula (1).

Examples of the halogen atom represented by R¹¹ to R⁷⁸ in general formula (7) include a fluorine atom, a chlorine atom, a bromine atom, and an iodine atom.

The group represented by R⁷⁸ in general formula (7) may be an alkoxy carbonyl group (—C(═O)—O—R^{78A}) from the viewpoint of further reducing the residual potential. R^{78A} represents an alkyl group having 8 or more carbon atoms (long chain alkyl group) or L¹⁸¹-O—R¹⁸² where L¹⁸¹ represents an alkylene group and R¹⁸² represents an alkyl group having 8 or more carbon atoms (long chain alkyl group).

In the group represented by -L¹⁸¹-O—R¹⁸² represented by R⁷⁸ in general formula (7), L¹⁸¹ represents an alkylene group and R¹⁸² represents an alkyl group having 8 or more carbon atoms (long chain alkyl group).

Examples of the alkylene group represented by L¹⁸¹ include linear or branched alkylene groups having 1 to 12 carbon atoms, specifically, a methylene group, an ethylene group, an n-propylene group, an isopropylene group, an n-butylene group, an isobutylene group, a sec-butylene group, a tert-butylene group, an n-pentylene group, an isopentylene group, a neopentylene group, and a tert-pentylene group.

The long chain alkyl group represented by R¹⁸² may be any alkyl group having 8 or more carbon atoms, and preferably has 8 to 12 carbon atoms from the viewpoint of suppressing cracking in the photosensitive layer. The long chain alkyl group may be linear or branched and is preferably linear.

Examples of the linear alkyl group having 8 to 12 carbon atoms include an n-octyl group, an n-nonyl group, an n-decyl group, an n-undecyl group, and an n-dodecyl group.

Examples of the branched alkyl groups having 8 to 12 carbon atoms include an isooctyl group, a sec-octyl group, a tert-octyl group, an isononyl group, a sec-nonyl group, a tert-nonyl group, an isodecyl group, a sec-decyl group, and a tert-decyl group.

The compound represented by general formula (7) may have only one long chain alkyl group in a molecule or two or more long chain alkyl groups in a molecule. The number of long chain alkyl groups contained in one molecule of the compound represented by general formula (7) is preferably 1 or more and 3 or less and more preferably 1 or more and 2 or less from the viewpoint of suppressing cracking in the photosensitive layer.

In one exemplary embodiment, from the viewpoint of further reducing the residual potential, the compounds represented by general formula (7) may have R⁷¹ to R⁷⁷ each independently representing a hydrogen atom, a halogen atom, or an alkyl group and R⁷⁸ representing a linear alkyl group having 8 or less carbon atoms.

In the description below, example compounds of the compounds represented by general formula (7) are described, and these examples are not limiting. Note that an example compound number below is hereinafter indicated as an example compound (7-number). Specifically, for example, an example compound 5 is referred to as an “example compound (7-5).

| Example | | | | | | | | | |
|---|---|---|---|---|---|---|---|---|---|
| compound | R⁷¹ | R⁷² | R⁷³ | R⁷⁴ | R⁷⁵ | R⁷⁶ | R⁷⁷ | R⁷⁸ | Z |
| 1 | H | H | H | H | H | H | H | —C(═O)—O—CH₃ | ═C(CN)₂ |
| 2 | H | H | H | H | H | H | H | —C(═O)—O—C₂H₅ | ═C(CN)₂ |
| 3 | H | H | H | H | H | H | H | —C(═O)—O-n-C₄H₉ | ═C(CN)₂ |
| 4 | H | H | H | H | H | H | H | —C(═O)—O-t-C₄H₉ | ═C(CN)₂ |
| 5 | H | H | H | H | H | H | H | —C(═O)—O-n-C₈H₁₇ | ═C(CN)₂ |
| 6 | H | H | H | H | H | H | H | —C(═O)—O-n-CH₂—CH(C₂H₅)—C₄H₉ | ═C(CN)₂ |
| 7 | H | H | H | H | H | H | H | —C(═O)—O-n-C₄H₉ | O |
| 8 | H | H | H | H | H | H | H | —C(═O)—O-n-CH₂—CH(C₂H₅)—C₄H₉ | O |

Abbreviations in the aforementioned example compounds are as follows.
═C(CN)₂: dicyanomethylene group

### Compounds Represented by General Formula (8)

Compounds represented by general formula (8) will now be described.

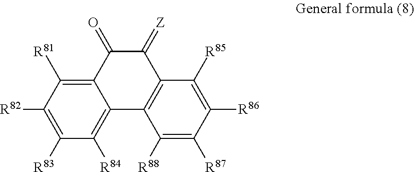

In general formula (8), R⁸¹, R⁸², R⁸³, R⁸⁴, R⁸⁵, R⁸⁶, R⁸⁷, and R⁸⁸ (hereinafter may be simply referred to as “R⁸¹ to R⁸⁸”) each independently represent a hydrogen atom, an alkyl group, an alkoxy group, an aralkyl group, an aryl group, an acyl group, an alkoxycarbonyl group, or a halogen atom, and Z represents an oxygen atom or a dicyanomethylene group (═C(CN)₂).

Examples of the alkyl group, the alkoxy group, the aralkyl group, the aryl group, the acyl group, the alkoxycarbonyl group, and the halogen atom represented by R⁸¹ to R⁸⁸ in general formula (8) include the same groups and atoms as the alkyl groups, the alkoxy groups, the aralkyl groups, the aryl groups, the acyl groups, the alkoxycarbonyl groups, and the halogen atoms represented by R⁷¹ to R⁷⁸ in general formula (7).

The alkyl group, the alkoxy group, the aralkyl group, the aryl group, and the alkoxycarbonyl group represented by R⁸¹ to R⁸⁸ in general formula (8) may each have a substituent the same as the substituent for the alkyl group, the alkoxy group, the aralkyl group, the aryl group, and the alkoxycarbonyl group represented by R¹¹ to R¹⁸ in general formula (1).

The acyl group represented by R⁸¹ to R⁸⁸ in general formula (8) may have a substituent the same as the substituent for the alkyl group represented by R¹¹ to R¹⁸ in general formula (1).

In the description below, example compounds of the compounds represented by general formula (8) are described, and these examples are not limiting. Note that an example compound number below is hereinafter indicated as an example compound (8-number). Specifically, for example, an example compound 5 is referred to as an “example compound (8-5).

| Example | | | | | | | | |
|---|---|---|---|---|---|---|---|---|
| compound | R⁸¹ | R⁸² | R⁸³ | R⁸⁴ | R⁸⁵ | R⁸⁶ | R⁸⁷ | Z |
| 1 | H | H | H | H | H | H | H | O |
| 2 | H | —Br | H | H | H | H | H | O |
| 3 | H | H | —Br | H | H | H | —Br | O |
| 4 | H | —CN | H | H | H | H | H | O |
| 5 | —CH₃ | H | H | H | H | H | H | O |
| 6 | H | —OCH₃ | H | H | H | H | H | O |
| 7 | —CH₂CH₃ | H | H | H | H | —CH₃ | H | O |
| 8 | H | H | —C(═O)CH₃ | H | H | H | H | O |
| 9 | H | H | H | H | H | H | H | ═C(CN)₂ |
| 10 | —CH₃ | H | H | H | H | —CH₃ | H | ═C(CN)₂ |

Abbreviations in the aforementioned example compounds are as follows.
C(═O)CH₃: acetyl group
OCH₃: methoxy group
CN: cyano group
CH₂C₆H₅: benzyl group
═C(CN)₂: dicyanomethylene group

The electron transport material content relative to all solid components in the undercoat layer is preferably 50 mass % or more and 80 mass % or less, more preferably 55 mass % or more and 75 mass % or less, and yet more preferably 60 mass % or more and 70 mass % or less. When two or more electron transport materials are used in combination, the electron transport material content refers to the total amount of the two or more electron transport materials.

When the electron transport material content is 80 mass % or less, occurrence of surface roughness on the undercoat layer caused by brittle film quality and degraded film forming properties is suppressed, and the charge-retaining property is further improved. When the electron transport material content is 50 mass % or more, deficiency and excess of the electron transport ability are suppressed, and the residual potential is further reduced.

### Butyral Resin

When a butyral resin is contained in the composition, the butyral resin content relative to all solid components in the undercoat layer is 5 mass % or less, preferably 4 mass % or less, and more preferably 3 mass % or less. The butyral resin content in the composition may be 0 mass %, in other words, the composition may contain no butyral resin.

When the butyral resin content in the composition is 5 mass % or less or when no butyral resin is contained, the electron transport material and the hole transport compound in the undercoat layer are easily dispersed with high uniformity, and the coating solution stability and the film forming property are improved. As a result, a photoreceptor having an excellent charge-retaining property with a further lower residual potential can be easily obtained.

### Curing Agent

The composition contains a curing agent.

When the composition contains a curing agent, the curing agent reacts with the reactive group-containing triarylamine compound to form a cured film, and the residual potential is reduced.

At least one curing agent selected from an isocyanate compound and a melamine resin is preferably contained as the curing agent, and an isocyanate compound is more preferably contained as the curing agent.

When an isocyanate compound is contained as the curing agent, the isocyanate compound more efficiently reacts with the reactive group-containing triarylamine compound to form a cured film, and thus the charge-retaining property is further improved and the residual potential is further reduced.

When one of a melamine resin and a benzoguanamine resin is contained as the curing agent and a cured film is formed, the resin easily suppresses injection of holes in the film into the charge generation material (in other words, the hole-blocking effect is enhanced). Thus, the potential decay on the surface of the photoreceptor is inhibited.

Examples of the isocyanate compound include the following:

diisocyanates such as methylene diisocyanate, ethylene diisocyanate, isophorone diisocyanate, hexamethylene diisocyanate, 1,4-cyclohexane diisocyanate, 2,4-toluene diisocyanate, 2,6-toluene diisocyanate, 1,3-xylylene diisocyanate, 1,5-naphthalene diisocyanate, m-phenyhlene diisocyanate, p-phenylene diisocyanate, 3,3′-dimethyl-4,4′-diphenylmethane diisocyanate, 3,3′-dimethylbiphenylene diisocyanate, 4,4′-biphenylene diisocyanate, dicyclohexylmethane diisocyanate, methylenebis(4-cyclohexylisocyanate); and isocyanurates obtained by trimerization of these diisocyanates; and blocked isocyanates obtained by blocking the isocyanate groups of the aforementioned diisocyanates with blocking agents such as methyl ethyl ketone oxime, phenol, or an alcohol.

Among these, the isocyanate compound is preferably a polyfunctional isocyanate compound such as an isocyanurate having two or more isocyanate groups, or a blocked isocyanate. In particular, the blocked isocyanate is preferable from the viewpoints of the production ease and stability.

The isocyanate compound may be an oligomer or a resin from the viewpoint of further improving the film forming property.

Examples of the curing agent other than the aforementioned isocyanate compounds, the melamine resins, and the benzoguanamine resins include polyols other than butyral resins.

Examples of the polyols other than butyral resins include diols such as ethylene glycol, 1,2-propanediol, 1,3-propanediol, 1,2-butanediol, 1,3-butanediol, 2,3-butanediol, 2,2-dimethyl-1,3-propanediol, 1,2-pentanediol, 1,4-pentanediol, 1,5-pentanediol, 2,4-pentanediol, 3,3-dimethyl-1,2-butanediol, 2-ethyl-2-methyl-1,3-propanediol, 1,2-hexanediol, 1,5-hexanediol, 1,6-hexanediol, 2,5-hexanediol, 2-methyl-2,4-pentanediol, 2,2-diethyl-1,3-propanediol, 2,4-dimethyl-2,4-pentanediol, 1,7-heptanediol, 2-methyl-2-propyl-1,3-propanediol, 2,5-dimethyl-2,5-hexanediol, 2-ethyl-1,3-hexanediol, 1,2-octanediol, 1,8-octanediol, 2,2,4-trimethyl-1,3-pentanediol, 1,4-cyclohexanedimethanol, hydroquinone, diethylene glycol, triethylene glycol, dipropylene glycol, tripropylene glycol, polyethylene glycol, polypropylene glycol, poly(oxytetramethylene) glycol, 4,4′-dihydroxydiphenyl-2,2-propane, and 4,4′-dihydroxyphenylsulfone.

Other examples of the polyols other than the butyral resins include polyester polyols, polycarbonate polyols, polycaprolactone polyols, and polyether polyols, and these polyols may be used alone or in combination.

### Curing Catalyst

Examples of the curing catalyst include amine compounds, organic acid metal salts, and organic metal complexes.

Examples of the amine compounds include 1,4-diazabicyclo(2,2,2)octane, N, N-dimethylcyclohexylamine, N-methyldicyclohexylamine, N,N,N′,N′-tetramethylpropylenediamine, N-ethylmorpholine, N-methylmorpholine, N,N-dimethylethanolamine, 1,8-diazabicyclo[5,4,0]undecene-7 (DBU), and salts thereof.

Examples of the organic acid metal salts and organic metal complexes include dibutyltin laurate, stannous octoate, bismuth octylate, bismuth naphthenate, bismuth salicylate, zinc octylate, zinc naphthenate, and zinc salicylate.

Examples of the commercially available products of urethane curing catalysts include K-KAT series produced by King Industries, Inc., such as bismuth carboxylate catalysts such as K-KAT348, K-KAT XC-C227, K-KAT XK-628, and K-KAT XK-640, aluminum complex catalysts such as K-KAT5218, and zirconium complex catalysts such as K-KAT4205, K-KAT6212, and K-KATA209; and ORGATIX series produced by Matsumoto Fine Chemical Co., Ltd., such as titanium complex catalysts such as TA-30 and TC-750.

Polyurethane preferably accounts for 80 mass % or more and 100 mass % or less, more preferably 90 mass % or more and 100 mass % or less, and yet more preferably 95 mass % or more and 100 mass % or less of the total amount of the resins contained in the undercoat layer.

The mass ratio of the total amount of the electron transport materials contained in the undercoat layer to the amount of the polyurethane contained in the undercoat layer is preferably 90:10 to 50:50 and more preferably 80:20 and 70:30.

### Inorganic Particles

The composition may further contain inorganic particles.

Examples of the inorganic particles include inorganic particles having a powder resistance (volume resistivity) of 102 Ωcm or more and 1011 Ωcm or less.

As the inorganic particles having this resistance value, for example, metal oxide particles such as tin oxide particles, titanium oxide particles, zinc oxide particles, or zirconium oxide particles are preferable, and, in particular, zinc oxide particles are preferable.

The BET specific surface area of the inorganic particles may be, for example, 10 m²/g or more. At a specific surface area of 10 m²/g or more, degradation of chargeability tends to be reduced.

The volume average particle diameter of the inorganic particles is, for example, 50 nm or more and 2000 nm or less (preferably 60 nm or more and 1000 nm or less).

The inorganic particle content relative to all solid components in the undercoat layer is preferably 0 mass % or more and 80 mass % or less and more preferably 0 mass % or more and 70 mass % or less.

The surfaces of the inorganic particles may be treated. Two or more types of inorganic particles subjected to different surface treatment or having different particle diameters may be mixed and used.

Examples of the surface treating agent include silane coupling agents, titanate coupling agents, aluminum coupling agents, and surfactants. In particular, silane coupling agents are preferable, and an amino-group-containing silane coupling agent is more preferable.

Examples of the amino-group-containing silane coupling agent include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

Two or more silane coupling agents may be mixed and used. For example, an amino-group-containing silane coupling agent may be used in combination with another silane coupling agent. Examples of this other silane coupling agent include, but are not limited to, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment method that uses a surface treating agent may be any known method, for example, may be a dry method or a wet method.

The amount of the surface treating agent relative to the inorganic particles may be, for example, 0.5 mass % or more and 10 mass % or less.

The dry method is, for example, a method that involves adding, to inorganic particles being stirred with a mixer at a large shear force, a surface treating agent directly, dropwise as a solution prepared by dissolving the surface treating agent in an organic solvent, or via spraying along with dry air or nitrogen gas so that the surface treating agent attaches to the surfaces of the inorganic particles. When the surface treating agent is added dropwise or sprayed, the temperature may be lower than or equal to the boiling point of the solvent. After the dropwise addition or spraying of the surface treating agent, baking may be further performed at a temperature equal to or higher than 100° C. The temperature and time for baking may be any as long as the electrophotographic properties are obtained.

The wet method is, for example, a method that involves adding a surface treating agent while dispersing inorganic particles in a solvent by stirring, ultrasonically, or by using a sand mill, an attritor, or a ball mill, stirring or dispersing the resulting mixture, and then removing the solvent so that the surface treating agent attaches to the surfaces of the inorganic particles. The solvent is removed by, for example, filtration or distillation. After removing the solvent, baking may be further performed at a temperature equal to or higher than 100° C. The temperature and time for baking may be any as long as the electrophotographic properties are obtained. In the wet method, the water contained in the inorganic particles may be removed before adding the surface treating agent, and examples of such a method include a method that removes the water by stirring and heating the inorganic particles in a solvent and a method of removing water by boiling together with the solvent.

### Additives

The undercoat layer may contain various additives to improve the electrical characteristics, environmental stability, and image quality.

Examples of the additives include known materials such as electron transporting pigments based on polycondensate materials and azo materials, zirconium chelate compounds, titanium chelate compounds, aluminum chelate compounds, titanium alkoxide compounds, organic titanium compounds, and silane coupling agents. The silane coupling agent is used to surface-treat the inorganic particles as mentioned above, but may be further added as an additive to the undercoat layer.

Examples of this silane coupling agent serving as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compounds include zirconium butoxide, zirconium ethyl acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, and isostearate zirconium butoxide.

Examples of the titanium chelate compounds include tetraisopropyl titanate, tetra-n-butyl titanate, butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compounds include aluminum isopropylate, monobutoxyaluminum diisopropylate, aluminum butyrate, diethylacetoacetate aluminum diisopropylate, and aluminum tris(ethylacetoacetate).

These additives may be used alone, or as a mixture or a polycondensation product of two or more compounds.

### Other Properties of Undercoat Layer

The undercoat layer may have a volume resistivity of 1×10¹⁰ Ωcm or more and 1×10¹² Ωcm or less.

The undercoat layer may have a Vickers hardness of 35 or more.

In order to suppress moire images, the surface roughness (ten-point average roughness) of the undercoat layer may be adjusted to be in the range of 1/(4n) (n represents the refractive index of the overlying layer) to ½ of λ representing the laser wavelength used for exposure.

In order to adjust the surface roughness, resin particles and the like may be added to the undercoat layer. Examples of the resin particles include silicone resin particles and crosslinking polymethyl methacrylate resin particles. The surface of the undercoat layer may be polished to adjust the surface roughness. Examples of the polishing method include buff polishing, sand blasting, wet honing, and grinding.

### Method for Forming Undercoat Layer

The undercoat layer may be formed by any known method, and, for example, may be formed by preparing an undercoat layer-forming solution by adding the above-mentioned components to a solvent, forming a coating film of this solution, and drying and, if desired, heating the coating film.

Examples of the solvent used for preparing the undercoat layer-forming solution include known organic solvents, such as alcohol solvents, aromatic hydrocarbon solvents, halogenated hydrocarbon solvents, ketone solvents, ketone alcohol solvents, ether solvents, and ester solvents.

Specific examples of the solvent include common organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method for dispersing inorganic particles in preparing the undercoat layer-forming solution include known methods that use a roll mill, a ball mill, a vibrating ball mill, an attritor, a sand mill, a colloid mill, and a paint shaker.

Since the electron transport materials (in particular, compounds represented by general formula (1) to general formula (8)) are sparingly soluble in an organic solvent, an organic solvent may be used for dispersing. Examples of the dispersing method include known methods that use a roll mill, a ball mill, a vibrating ball mill, an attritor, a sand mill, a colloid mill, and a paint shaker. When metal oxide particles are to be blended into the undercoat layer, the metal oxide particles may be dispersed in an organic solvent by a dispersing method similar to those described above.

Examples of the method for applying the undercoat layer-forming solution to the conductive substrate include common methods such as a blade coating method, a wire bar coating method, a spray coating method, a dip coating method, a bead coating method, an air knife coating method, and a curtain coating method.

The thickness of the undercoat layer is preferably 1 μm or more and more preferably 3 μm or more.

From the viewpoint of improving the charge-retaining property, the thickness of the undercoat layer is preferably 50 μm or less, more preferably 30 μm or less, and yet more preferably 20 μm or less.

### Conductive Substrate

Examples of the conductive substrate include metal plates, metal drums, and metal belts that contain metals (aluminum, copper, zinc, chromium, nickel, molybdenum, vanadium, indium, gold, platinum, etc.) or alloys (stainless steel etc.). Other examples of the conductive substrate include paper sheets, resin films, and belts coated, vapor-deposited, or laminated with conductive compounds (for example, conductive polymers and indium oxide), metals (for example, aluminum, palladium, and gold), or alloys. Here, “conductive” means having a volume resistivity of less than 10¹³ Ωcm.

The surface of the conductive substrate may be roughened to a center-line average roughness Ra of 0.04 μm or more and 0.5 μm or less in order to suppress interference fringes that occur when the electrophotographic photoreceptor used in a laser printer is irradiated with a laser beam. When incoherent light is used as a light source, there is no need to roughen the surface to reduce interference fringes, but roughening the surface suppresses generation of defects due to irregularities on the surface of the conductive substrate and thus is desirable for extending the lifetime.

Examples of the surface roughening method include a wet honing method with which an abrasive suspended in water is sprayed onto a conductive substrate, a centerless grinding with which a conductive substrate is pressed against a rotating grinding stone to perform continuous grinding, and an anodization treatment.

Another example of the surface roughening method does not involve roughening the surface of a conductive substrate but involves dispersing a conductive or semi-conductive powder in a resin and forming a layer of the resin on a surface of a conductive substrate so as to create a rough surface by the particles dispersed in the layer.

The surface roughening treatment by anodization involves forming an oxide film on the surface of a conductive substrate by anodization by using a metal (for example, aluminum) conductive substrate as the anode in an electrolyte solution. Examples of the electrolyte solution include a sulfuric acid solution and an oxalic acid solution. However, a porous anodized film formed by anodization is chemically active as is, is prone to contamination, and has resistivity that significantly varies depending on the environment. Thus, a pore-sealing treatment may be performed on the porous anodized film so as to seal fine pores in the oxide film by volume expansion caused by hydrating reaction in pressurized steam or boiling water (a metal salt such as a nickel salt may be added) so that the oxide is converted into a more stable hydrous oxide.

The thickness of the anodized film may be, for example, 0.3 μm or more and more preferably 15 μm or more. When the thickness is within this range, a barrier property against injection tends to be exhibited, and the increase in residual potential caused by repeated use tends to be suppressed.

The conductive substrate may be subjected to a treatment with an acidic treatment solution or a Boehmite treatment.

The treatment with an acidic treatment solution is, for example, conducted as follows. First, an acidic treatment solution containing phosphoric acid, chromic acid, and hydrofluoric acid is prepared. The blend ratios of phosphoric acid, chromic acid, and hydrofluoric acid in the acidic treatment solution may be, for example, in the range of 10 mass % or more and 11 mass % or less for phosphoric acid, in the range of 3 mass % or more and 5 mass % or less for chromic acid, and in the range of 0.5 mass % or more and 2 mass % or less for hydrofluoric acid; and the total concentration of these acids may be in the range of 13.5 mass % or more and 18 mass % or less. The treatment temperature may be, for example, 42° C. or higher and 48° C. or lower. The thickness of the coating film may be 0.3 μm or more and more and 15 μm or less.

The Boehmite treatment is conducted by immersing a conductive substrate in pure water at 90° C. or higher and 100° C. or lower for 5 to 60 minutes or by bringing a conductive substrate into contact with pressurized steam at 90° C. or higher and 120° C. or lower for 5 to 60 minutes. The thickness of the coating film may be 0.1 μm or more and more and 5 μm or less. The resulting substrate may be further anodized by using an electrolyte solution, such as adipic acid, boric acid, a borate salt, a phosphate salt, a phthalate salt, a maleate salt, a benzoate salt, a tartrate salt, or a citrate salt, that has low film-dissolving power.

### Intermediate Layer

Although not illustrated in the drawings, an intermediate layer may be further formed between the undercoat layer and the photosensitive layer.

The intermediate layer is, for example, a layer that contains a resin. Examples of the resin used in the intermediate layer include polymer compounds such as acetal resins (for example, polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may contain an organic metal compound. Examples of the organic metal compound used in the intermediate layer include organic metal compounds containing metal atoms such as zirconium, titanium, aluminum, manganese, and silicon.

These compounds used in the intermediate layer may be used alone, or two or more compounds may be used as a mixture or a polycondensation product.

In particular, the intermediate layer may be a layer that contains an organic metal compound that contains zirconium atoms or silicon atoms.

The intermediate layer may be formed by any known method, and, for example, may be formed by preparing an intermediate layer-forming solution by adding the above-mentioned components to a solvent, forming a coating film of this solution, and drying and, if desired, heating the coating film.

Examples of the application method for forming the intermediate layer include common methods such as a dip coating method, a lift coating method, a wire bar coating method, a spray coating method, a blade coating method, a knife coating method, and a curtain coating method.

The thickness of the intermediate layer may be set within the range of, for example, 0.1 μm or more and 3 μm or less. The intermediate layer may be used as the undercoat layer.

### Charge Generation Layer

The charge generation layer is a layer that contains a charge generation material and a binder resin. The charge generation layer may be a layer formed by vapor-depositing a charge generation material. The vapor deposited layer of the charge generation material may be used when an incoherent light source such as a light emitting diode (LED) or an organic electro-luminescence (EL) image array is used.

Examples of the charge generation material include azo pigments such as bisazo and trisazo pigments; fused-ring aromatic pigments such as dibromoanthanthrone; perylene pigments; pyrrolopyrrole pigments; phthalocyanine pigments; zinc oxide; and trigonal selenium.

Among these, in order to be compatible to the near-infrared laser exposure, a metal phthalocyanine pigment or a metal-free phthalocyanine pigment may be used as the charge generation material. Specific examples thereof include hydroxygallium phthalocyanine, chlorogallium phthalocyanine, dichlorotin phthalocyanine, and titanyl phthalocyanine.

In order to be compatible to the near ultraviolet laser exposure, the charge generation material may be a fused-ring aromatic pigment such as dibromoanthanthrone, a thioindigo pigment, a porphyrazine compound, zinc oxide, trigonal selenium, a bisazo pigment, or the like.

When an incoherent light source, such as an LED or an organic EL image array having an emission center wavelength in the range of 450 nm or more and 780 nm or less, is used, the charge generation material described above may be used; however, from the viewpoint of the resolution, when the photosensitive layer is as thin as 20 μm or less, the electric field intensity in the photosensitive layer is increased, charges injected from the substrate are decreased, and image defects known as black spots tend to occur. This is particularly noticeable when a charge generation material, such as trigonal selenium or a phthalocyanine pigment, that is of a p-conductivity type and is likely to generate dark current is used.

In contrast, when an n-type semiconductor, such as a fused-ring aromatic pigment, a perylene pigment, or an azo pigment, is used as the charge generation material, dark current rarely occurs and, even when the thickness is small, image defects known as black spots can be suppressed. Determination of the n-type is performed by a common time-of-flight method and by the polarity of the flowing photocurrent, and a material in which electrons rather than holes are likely to flow as a carrier is determined to be of an n-type.

The binder resin used in the charge generation layer is selected from a wide range of insulating resins. Alternatively, the binder resin may be selected from organic photoconductive polymers, such as poly-N-vinylcarbazole, polyvinyl anthracene, polyvinyl pyrene, and polysilane.

Examples of the binder resin include, polyvinyl butyral resins, polyarylate resins (polycondensates of bisphenols and aromatic dicarboxylic acids etc.), polycarbonate resins, polyester resins, phenoxy resins, vinyl chloride-vinyl acetate copolymers, polyamide resins, acrylic resins, polyacrylamide resins, polyvinyl pyridine resins, cellulose resins, urethane resins, epoxy resins, casein, polyvinyl alcohol resins, and polyvinyl pyrrolidone resins. Here, “insulating” means having a volume resistivity higher than equal to 10¹³ Ωcm.

These binder resins may be used alone or in combination as a mixture.

The blend ratio of the charge generation material to the binder resin may be 10:1 to 1:10 in terms of mass ratio.

The charge generation layer may contain other known additives.

The charge generation layer may be formed by any known method, and, for example, may be formed by preparing a charge generation layer-forming solution by adding the above-mentioned components to a solvent, forming a coating film of this solution, and drying and, if desired, heating the coating film. The charge generation layer may be a vapor deposited layer of a charge generation material. The charge generation layer may be formed by vapor deposition particularly when a fused-ring aromatic pigment or a perylene pigment is used as the charge generation material.

Specific examples of the solvent for preparing the charge generation layer-forming solution include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in combination as a mixture.

In order to disperse particles (for example, the charge generation material) in the charge generation layer-forming solution, a media disperser such as a ball mill, a vibrating ball mill, an attritor, a sand mill, or a horizontal sand mill, or a media-less disperser such as stirrer, an ultrasonic disperser, a roll mill, or a high-pressure homogenizer is used, for example. Examples of the high-pressure homogenizer include a collision-type homogenizer in which a dispersion in a high-pressure state is dispersed through liquid-liquid collision or liquid-wall collision, and a penetration-type homogenizer in which a fluid in a high-pressure state is caused to penetrate through fine channels.

In dispersing, it is effective to set the average particle diameter of the charge generation material in the charge generation layer-forming solution to 0.5 μm or less, preferably 0.3 μm or less, and more preferably 0.15 μm or less.

Examples of the method for applying the charge generation layer-forming solution to the undercoat layer (or the intermediate layer) include common methods such as a blade coating method, a wire bar coating method, a spray coating method, a dip coating method, a bead coating method, an air knife coating method, and a curtain coating method.

The thickness of the charge generation layer is preferably set within the range of 0.1 μm or more and 5.0 μm or less, and more preferably within the range of 0.2 μm or more and 2.0 μm or less.

### Charge Transport Layer

The charge transport layer is, for example, a layer that contains a charge transport material and a binder resin. The charge transport layer may be a layer that contains a polymer charge transport material.

Examples of the charge transport material include electron transport compounds such as quinone compounds such as p-benzoquinone, chloranil, bromanil, and anthraquinone; tetracyanoquinodimethane compounds; fluorenone compounds such as 2,4,7-trinitrofluorenone; xanthone compounds; benzophenone compounds; cyanovinyl compounds; and ethylene compounds. Other examples of the charge transport material include hole transport compounds such as triarylamine compounds, benzidine compounds, aryl alkane compounds, aryl-substituted ethylene compounds, stilbene compounds, anthracene compounds, and hydrazone compounds. These charge transport materials may be used alone or in combination, but are not limiting.

From the viewpoint of charge mobility, the charge transport material may be a triarylamine derivative represented by structural formula (a-1) below or a benzidine derivative represented by structural formula (a-2) below.

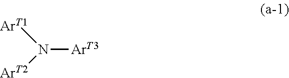

In structural formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent for each of the groups described above include halogen atoms, alkyl groups having 1 to 5 carbon atoms, and alkoxy groups having 1 to 5 carbon atoms. Examples of the substituent for each of the groups described above include substituted amino groups substituted with alkyl groups having 1 to 3 carbon atoms.

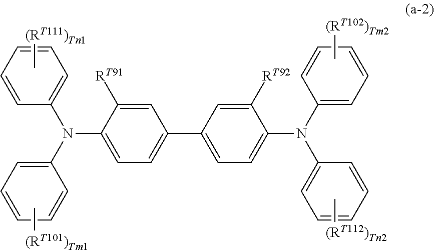

In structural formula (a-2), R^{T91} and R^{T92} each independently represent a hydrogen atom, a halogen atom, an alkyl group having 1 to 5 carbon atoms, or an alkoxy group having 1 to 5 carbon atoms. R^{T101}, R^{T102}, R^{T111}, and R^{T112} each independently represent a halogen atom, an alkyl group having 1 to 5 carbon atoms, an alkoxy group having 1 to 5 carbon atoms, an amino group substituted with an alkyl group having 1 or 2 carbon atoms, a substituted or unsubstituted aryl group, —C(R^{T12})═C(R^{T13})(R^{T14}), or —CH═CH—CH═C(R^{T15})(R^{T16}) where R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or more and 2 or less.

Examples of the substituent for each of the groups described above include halogen atoms, alkyl groups having 1 to 5 carbon atoms, and alkoxy groups having 1 to 5 carbon atoms. Examples of the substituent for each of the groups described above include substituted amino groups substituted with alkyl groups having 1 to 3 carbon atoms.

Here, among the triarylamine derivatives represented by structural formula (a-1) and the benzidine derivatives represented by structural formula (a-2) above, a triarylamine derivative having —C₆H₄—CH═CH—CH═C(R^{T7})(R^{T8}) or a benzidine derivative having —CH═CH—CH═C(R^{T15})(R^{T16}) may be used from the viewpoint of the charge mobility.

Examples of the polymer charge transport material that can be used include known charge transport materials such as poly-N-vinylcarbazole and polysilane. In particular, a polyester polymer charge transport material is preferable. These polymer charge transport materials may be used alone or each in combination with a binder resin.

Examples of the binder resin used in the charge transport layer include polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone alkyd resins, phenol-formaldehyde resins, styrene-alkyd resins, poly-N-vinylcarbazole, and polysilane. Among these, a polycarbonate resin or a polyarylate resin may be used as the binder resin. These binder resins are used alone or in combination.

The blend ratio of the charge transport material to the binder resin may be 10:1 to 1:5 in terms of mass ratio.

The charge transport layer may contain other known additives.

The charge transport layer may be formed by any known method, and, for example, may be formed by preparing a charge transport layer-forming solution by adding the above-mentioned components to a solvent, forming a coating film of this solution, and drying and, if desired, heating the coating film.

Examples of the solvent used to prepare the charge transport layer-forming solution include common organic solvents such as aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in combination as a mixture.

Examples of the method for applying the charge transport layer-forming solution to the charge generation layer include common methods such as a blade coating method, a wire bar coating method, a spray coating method, a dip coating method, a bead coating method, an air knife coating method, and a curtain coating method.

The thickness of the charge transport layer is preferably set within the range of 5 μm or more and 50 μm or less, and more preferably within the range of 10 μm or more and 30 μm or less.

### Protection Layer

The protection layer is disposed on the photosensitive layer as needed. The protection layer is provided for the purpose of preventing chemical changes in the photosensitive layer during charging and further improving the mechanical strength of the photosensitive layer.

Thus, the protection layer may be a layer formed of a cured film (crosslinked film). Examples of such a layer are 1) and 2) below.

1) a layer composed of a cured film of a composition that contains a reactive group-containing charge transport material that has a reactive group and a charge transport skeleton in the same molecule (in other words, a layer that contains a polymer or crosslinked body of the reactive group-containing charge transport material)

2) a layer composed of a cured film of a composition that contains a non-reactive charge transport material and a reactive group-containing non-charge transport material that has no charge transport skeleton but has a reactive group (in other words, a layer that contains a polymer or crosslinked body of the non-reactive charge transport material and the reactive group-containing non-charge transport material)

Examples of the reactive group contained in the reactive group-containing charge transport material include known reactive groups such as chain-polymerizable groups, an epoxy group, —OH, —OR (where R represents an alkyl group), —NH₂, —SH, —COOH, or —SiR^{Q1}_{3-Qn}(OR^{Q2})_{Qn} (where R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3).

The chain-polymerizable group may be any radical-polymerizable functional group, and an example thereof is a functional group having a group that contains at least a carbon-carbon double bond. A specific example thereof is a group that contains at least one selected from a vinyl group, a vinyl ether group, a vinyl thioether group, a styryl group (vinylphenyl group), an acryloyl group, a methacryloyl group, and derivatives thereof. Among these, the chain-polymerizable group may be a group that contains at least one selected from a vinyl group, a styryl group (vinylphenyl group), an acryloyl group, a methacryloyl group, and derivatives thereof due to their excellent reactivity.

The charge transport skeleton of the reactive group-containing charge transport material may be any known structure used in the electrophotographic photoreceptor, and examples thereof include skeletons that are derived from nitrogen-containing hole transport compounds, such as triarylamine compounds, benzidine compounds, and hydrazone compounds, and that are conjugated with nitrogen atoms. Among these, a triarylamine skeleton is preferable.

The reactive-group-containing charge transport material that has such a reactive group and a charge transport skeleton, the non-reactive charge transport material, and the reactive-group-containing non-charge transport material may be selected from among known materials.

The protection layer may contain other known additives.

The protection layer may be formed by any known method. For example, a coating film is formed by using a protection layer-forming solution prepared by adding the above-mentioned components to a solvent, dried, and, if needed, cured such as by heating.

Examples of the solvent used to prepare the protection layer-forming solution include aromatic solvents such as toluene and xylene, ketone solvents such as methyl ethyl ketone, methyl isobutyl ketone, and cyclohexanone, ester solvents such as ethyl acetate and butyl acetate, ether solvents such as tetrahydrofuran and dioxane, cellosolve solvents such as ethylene glycol monomethyl ether, and alcohol solvents such as isopropyl alcohol and butanol. These solvents are used alone or in combination as a mixture.

The protection layer-forming solution may be a solvent-free solution.

Examples of the application method used to apply the protection layer-forming solution onto the photosensitive layer (for example, the charge transport layer) include common methods such as a dip coating method, a lift coating method, a wire bar coating method, a spray coating method, a blade coating method, a knife coating method, and a curtain coating method.

The thickness of the protection layer is preferably set within the range of 1 μm or more and 20 μm or less, and more preferably within the range of 2 μm or more and 10 μm or less.

### Single-Layer-Type Photosensitive Layer

A single-layer-type photosensitive layer (charge generation/charge transport layer) is, for example, a layer that contains a charge generation material, a charge transport material, and, if needed, a binder resin and other known additives. These materials are the same as those described in relation to the charge generation layer and the charge transport layer.

The amount of the charge generation material contained in the single-layer-type photosensitive layer relative to all solid components may be 0.1 mass % or more and 10 mass % or less, and is preferably 0.8 mass % or more and 5 mass % or less. The amount of the charge transport material contained in the single-layer-type photosensitive layer relative to all solid components may be 5 mass % or more and 50 mass % or less.

The method for forming the single-layer-type photosensitive layer is the same as the method for forming the charge generation layer and the charge transport layer.

The thickness of the single-layer-type photosensitive layer may be, for example, 5 μm or more and 50 μm or less, and is preferably 10 μm or more and 40 μm or less. Image forming apparatus and process cartridge

An image forming apparatus of an exemplary embodiment includes an electrophotographic photoreceptor, a charging unit that charges a surface of the electrophotographic photoreceptor, an electrostatic latent image forming unit that forms an electrostatic latent image on the charged surface of the electrophotographic photoreceptor, a developing unit that develops the electrostatic latent image on the surface of the electrophotographic photoreceptor by using a developer that contains a toner so as to form a toner image, and a transfer unit that transfers the toner image onto a surface of a recording medium. The electrophotographic photoreceptor of the exemplary embodiment described above is used as the electrophotographic photoreceptor.

The image forming apparatus of the exemplary embodiment is applied to a known image forming apparatus, examples of which include an apparatus equipped with a fixing unit that fixes the toner image transferred onto the surface of the recording medium; a direct transfer type apparatus with which the toner image formed on the surface of the electrophotographic photoreceptor is directly transferred to the recording medium; an intermediate transfer type apparatus with which the toner image formed on the surface of the electrophotographic photoreceptor is first transferred to a surface of an intermediate transfer body and then the toner image on the surface of the intermediate transfer body is transferred to the surface of the recording medium; an apparatus equipped with a cleaning unit that cleans the surface of the electrophotographic photoreceptor after the toner image transfer and before charging; an apparatus equipped with a charge erasing unit that erases the charges on the surface of the electrophotographic photoreceptor by applying the charge erasing light after the toner image transfer and before charging; and an apparatus equipped with an electrophotographic photoreceptor heating member that elevates the temperature of the electrophotographic photoreceptor to reduce the relative temperature.

In the intermediate transfer type apparatus, the transfer unit includes, for example, an intermediate transfer body having a surface onto which a toner image is to be transferred, a first transfer unit that conducts first transfer of the toner image on the surface of the electrophotographic photoreceptor onto the surface of the intermediate transfer body, and a second transfer unit that conducts second transfer of the toner image on the surface of the intermediate transfer body onto a surface of a recording medium.

The image forming apparatus of this exemplary embodiment may be of a dry development type or a wet development type (development type that uses a liquid developer).

In the image forming apparatus of the exemplary embodiment, for example, a section that includes the electrophotographic photoreceptor may be configured as a cartridge structure (process cartridge) detachably attachable to the image forming apparatus. A process cartridge equipped with the electrophotographic photoreceptor of the present exemplary embodiment may be used as this process cartridge. The process cartridge may include, in addition to the electrophotographic photoreceptor, at least one selected from the group consisting of a charging unit, an electrostatic latent image forming unit, a developing unit, and a transfer unit.

Hereinafter, one example of the image forming apparatus of the exemplary embodiment is described, but this exemplary embodiment is not limiting. Only the relevant parts in the drawing are described, and descriptions for other parts are omitted.

FIG. 2 is a schematic diagram illustrating one example of an image forming apparatus according to an exemplary embodiment.

As illustrated in FIG. 2, an image forming apparatus 100 of this exemplary embodiment includes a process cartridge 300 equipped with an electrophotographic photoreceptor 7, an exposing device 9 (one example of the electrostatic latent image forming unit), a transfer device 40 (first transfer device), and an intermediate transfer body 50. In this image forming apparatus 100, the exposing device 9 is positioned so that light can be applied to the electrophotographic photoreceptor 7 from the opening of the process cartridge 300, the transfer device 40 is positioned to oppose the electrophotographic photoreceptor 7 with the intermediate transfer body 50 therebetween, and the intermediate transfer body 50 has a portion in contact with the electrophotographic photoreceptor 7. Although not illustrated in the drawings, a second transfer device that transfers the toner image on the intermediate transfer body 50 onto a recording medium (for example, a paper sheet) is also provided. The intermediate transfer body 50, the transfer device 40 (first transfer device), and the second transfer device (not illustrated) correspond to examples of the transfer unit.

The process cartridge 300 illustrated in FIG. 2 integrates and supports the electrophotographic photoreceptor 7, a charging device 8 (one example of the charging unit), a developing device 11 (one example of the developing unit), and a cleaning device 13 (one example of the cleaning unit) in the housing. The cleaning device 13 has a cleaning blade (one example of the cleaning member) 131, and the cleaning blade 131 is in contact with the surface of the electrophotographic photoreceptor 7. The cleaning member may take a form other than the cleaning blade 131, and may be a conductive or insulating fibrous member that can be used alone or in combination with the cleaning blade 131.

Although an example of the image forming apparatus equipped with a fibrous member 132 (roll) that supplies a lubricant 14 to the surface of the electrophotographic photoreceptor 7 and a fibrous member 133 (flat brush) that assists cleaning is illustrated in FIG. 2, these members are optional.

The features of the image forming apparatus of this exemplary embodiment will now be described.

### Charging Device

Examples of the charging device 8 include contact-type chargers that use conductive or semi-conducting charging rollers, charging brushes, charging films, charging rubber blades, and charging tubes. Known chargers such as non-contact-type roller chargers, and scorotron chargers and corotron chargers that utilize corona discharge are also used.

### Exposing Device

Examples of the exposing device 9 include optical devices that can apply light, such as semiconductor laser light, LED light, or liquid crystal shutter light, into a particular image shape onto the surface of the electrophotographic photoreceptor 7. The wavelength of the light source is to be within the spectral sensitivity range of the electrophotographic photoreceptor. The mainstream wavelength of the semiconductor lasers is near infrared having an oscillation wavelength at about 780 nm. However, the wavelength is not limited to this, and a laser having an oscillation wavelength on the order of 600 nm or a blue laser having an oscillation wavelength of 400 nm or more and 450 nm or less may be used. In order to form a color image, a surface-emitting laser light source that can output multi beams is also effective.

### Developing Device

Examples of the developing device 11 include common developing devices that perform development by using a developer in a contact or non-contact manner. The developing device 11 is not particularly limited as long as the aforementioned functions are performed, and is selected according to the purpose. An example thereof is a known developer that has a function of attaching a one-component developer or a two-component developer to the electrophotographic photoreceptor 7 by using a brush, a roller, or the like. In particular, a development roller that retains the developer on its surface may be used.

The developer used in the developing device 11 may be a one-component developer that contains only a toner or a two-component developer that contains a toner and a carrier. The developer may be magnetic or non-magnetic. Any known developers may be used as these developers.

### Cleaning Device

A cleaning blade type device equipped with a cleaning blade 131 is used as the cleaning device 13.

Instead of the cleaning blade system, a fur brush cleaning system or a development-cleaning simultaneous system may be employed.

### Transfer Device

Examples of the transfer device 40 include contact-type transfer chargers that use belts, rollers, films, rubber blades, etc., and known transfer chargers such as scorotron transfer chargers and corotron transfer chargers that utilize corona discharge.

### Intermediate Transfer Body

A belt-shaped member (intermediate transfer belt) that contains semi-conducting polyimide, polyamide imide, polycarbonate, polyarylate, a polyester, a rubber, or the like is used as the intermediate transfer body 50. The form of the intermediate transfer body other than the belt may be a drum.

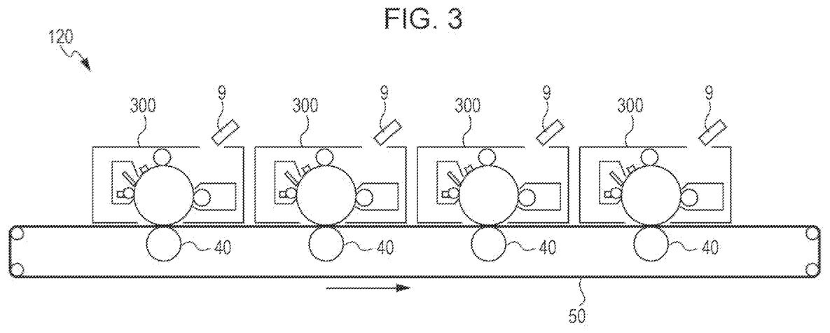

FIG. 3 is a schematic diagram illustrating another example of an image forming apparatus according to an exemplary embodiment.

An image forming apparatus 120 illustrated in FIG. 3 is a tandem-system multicolor image forming apparatus equipped with four process cartridges 300. In the image forming apparatus 120, four process cartridges 300 are arranged in parallel on the intermediate transfer body 50, and one electrophotographic photoreceptor is used for one color. The image forming apparatus 120 is identical to the image forming apparatus 100 except for the tandem system.

### EXAMPLES

The electrophotographic photoreceptor of the present disclosure will now be specifically described by way of examples. The materials, amounts used, ratios, treatment procedures, etc., that are described in the examples below are subject to alterations and modifications as appropriate without departing from the gist of the present disclosure. Thus, the interpretation of the scope of the electrophotographic photoreceptor of the present disclosure is not limited by the specific examples described below.

Example compounds assigned with example numbers corresponding to those in the description and the following amine compound are prepared as the reactive group-containing triarylamine compounds used in Examples and Comparative Examples.

### Amine Compound for Comparative Example

Amine compound (c1): 3,4-dimethyldiphenylamine (compound represented by the following formula)

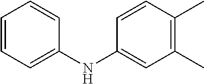

### Preparation of Electron Transport Material

Example compounds assigned with example numbers corresponding to those in the description are prepared as the electron transport materials used in Examples and Comparative Examples.

Types of resins and curing agents contained in composition
Blocked isocyanate (Sumidur BL3175 produced by Sumika Covestro Urethane Co., Ltd., solid content: 75 mass %)
Blocked isocyanate (Desmodur BL3475 produced by Sumika Covestro Urethane Co., Ltd., solid content: 75 mass %)
Blocked isocyanate (Desmodur BL3370 produced by Sumika Covestro Urethane Co., Ltd., solid content: 70 mass %)
Butyral resin (S-LEC BL-S produced by SEKISUI CHEMICAL CO., LTD.)
Butyral resin (S-LEC BM-1 produced by SEKISUI CHEMICAL CO., LTD.)
Methylated melamine resin (MW-30 produced by SANWA CHEMICAL CO., LTD.)

### Example 1

### Formation of Undercoat Layer

In 100 parts by mass of methyl ethyl ketone and 100 parts by mass of cyclopentanone, 46.7 parts by mass of blocked isocyanate BL3175 (solid content: 75%) which is an isocyanate compound serving as a curing agent, and 5 parts by mass of a reactive group-containing triarylamine compound (I-1) are dissolved. With the resulting solution, 60 parts by mass of an electron transport material (1-1) indicated in the table is mixed and dispersed in a sand mill along with glass beads having a diameter of 1 mm for 240 minutes. As a result, a dispersion is obtained. To the obtained dispersion, 0.001 parts by mass of bismuth carboxylate (K-KAT XK-640 produced by King Industries, Inc.) serving as a catalyst is added, and a coating solution for an undercoat layer is obtained as a result. This coating solution is applied to a cylindrical aluminum substrate by dip-coating, and dried and cured at 160° C. for 45 minutes. As a result, an undercoat layer having a thickness of 4.2 μm is formed.

### Formation of Charge Generation Layer

Hydroxygallium phthalocyanine having diffraction peaks at Bragg angles (2θ±0.2°) of at least 7.5°, 16.3°, 25.0°, and 28.3° in an X-ray diffraction spectrum taken by using CuKα radiation is prepared as a charge generation material. A mixture of 15 parts by mass of hydroxygallium phthalocyanine, 10 parts by mass of a vinyl chloride·vinyl acetate copolymer resin (VMCH produced by Nippon Unicar Company Limited), and 200 parts by mass of n-butyl acetate is dispersed in a sand mill for 4 hours by using glass beads having a diameter of 1 mm. To the obtained dispersion, 175 parts by mass of n-butyl acetate and 180 parts by mass of methyl ethyl ketone are added, and the resulting mixture is stirred to obtain a coating solution for forming a charge generation layer. This coating solution is applied to the undercoat layer by dip-coating, and dried and cured at 150° C. for 12 minutes. As a result, a charge generation layer having a thickness of 0.2 μm is formed.

### Formation of Charge Transport Layer

To 800 parts by mass of tetrahydrofuran, 38 parts by mass of a charge transport agent (HT-1), 10 parts by mass of a charge transport agent (HT-2), and 52 parts by mass of a polycarbonate (A) (viscosity-average molecular weight: 48,000) are added and dissolved. Thereto, 8 parts by mass of an ethylene tetrafluoride resin (LUBRON L-5 produced by Daikin Industries Ltd., average particle diameter: 300 nm) is added, and the resulting mixture is dispersed for 2 hours at 5500 rpm using a homogenizer (ULTRA-TURRAX produced by IKA Japan) to obtain a coating solution for forming a charge transport layer. This coating solution is applied to the charge generation layer by dip-coating, and dried and cured at 140° C. for 40 minutes. As a result, a charge transport layer having a thickness of 26 μm is formed. An electrophotographic photoreceptor of Example 1 is obtained as a result of these processes.

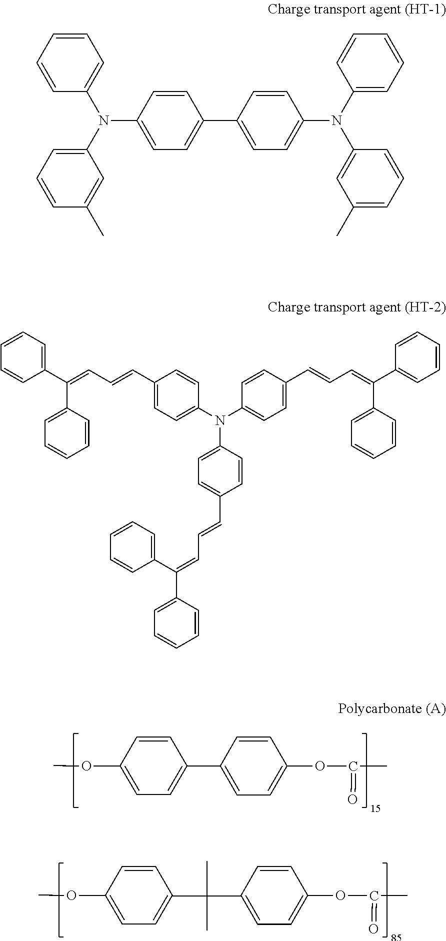

### Examples 2 to 21 and Comparative Examples 1 to 3

Photoreceptors are produced as in Example 1 except that, in forming an undercoat layer, the type and amount of the reactive group-containing triarylamine compound, the type and amount of the electron transport material, the type and amount of the curing agent, and the type and amount of the butyral resin are changed as indicated in Table 1. In the table, “-” means that the corresponding material is not used. The amount of each of the materials indicated in the table is the amount relative to all solid components in the undercoat layer.

### Evaluation of Performance of Photoreceptor

Each of the photoreceptors of Examples and Comparative Examples is loaded onto an image forming apparatus, DocuCentre C5570 produced by FUJIFILM Business Innovation Corp.), and performance is evaluated as follows in an environment having a temperature of 30° C. and a relative humidity of 85%. The results are indicated in the tables.

### Evaluation of Residual Potential

Each of the photoreceptors obtained in the examples is rotated at 100 rpm and charged to −700 V by using a scorotron charger, and, 0.05 seconds after the charging, the photoreceptor is irradiated with 2.0 mJ/m² of light using a semiconductor laser having a wavelength of 780 nm. To the photoreceptor 0.1 seconds after discharging, red LED light at 20 mJ/m² is applied to erase charges. The potential V of the surface of the photoreceptor 100 msec after charge erasing is measured, and the result is assumed to be the value of the residual potential.

### Evaluation Standard

G1: −50 V or higher
G2: lower than −50 V but not lower than −70 V
G3: lower than −70 V but not lower than −100 V
G4: lower than −100 V

### Charge-Retaining Property

A surface potential probe of a surface potentiometer (Trek 334 produced by Trek, Inc.) is placed at a position 1 mm away from the surface of the photoreceptor.

The decrease in potential (dark decay amount) 0.1 seconds after the surface of the photoreceptor is charged to −700 V is measured, and the decrease in potential is categorized into G1 to G4 below.

### Evaluation Standard

G1: The decrease in potential is less than 15 V.
G2: The decrease in potential is 15 V or more and less than 18 V.
G3: The decrease in potential is 18 V or more and less than 20 V.
G4: The decrease in potential is more than 20 V.

### Environmental Stability of Charge-Retaining Property

The environment having a temperature of 30° C. and a relative humidity of 85% is changed to an environment having a temperature of 15° C. and a relative humidity of 10%, and the charge-retaining property is measured. The difference in the measured values between the two environments (change in potential) is categorized into G1 to G4 below.

### Evaluation Standard

G1: The change in potential is less than 5 V.
G2: The change in potential is 5 V or more and less than 7 V.
G3: The change in potential is 7 V or more and less than 10 V.
G4: The change in potential is 10 V or more.

TABLE 1

| | Reactive group-containing | | Electron transport | | | |
|---|---|---|---|---|---|---|
| | triarylamine compound | | material | | Curing agent | |
| | | Amount [parts | | Amount [parts | | Amount [parts |
| | Type | by mass] | Type | by mass] | Type | by mass] |
| Example 1 | I-1 | 5 | 1-1 | 60 | Blocked isocyanate BL3175 | 46.7 |
| | | | | | (solid content: 75%) | |
| Example 2 | I-3 | 5 | 1-1 | 60 | Blocked isocyanate BL3175 | 40 |
| | | | | | (solid content: 75%) | |
| Example 3 | I-4 | 5 | 1-1 | 60 | Blocked isocyanate BL3175 | 50 |
| | | | | | (solid content: 75%) | |
| Example 4 | I-6 | 5 | 1-1 | 60 | Blocked isocyanate BL3475 | 40 |
| | | | | | (solid content: 75%) | |
| Example 5 | I-7 | 5 | 1-1 | 60 | Blocked isocyanate BL3370 | 53.6 |
| | | | | | (solid content: 70%) | |
| Example 6 | I-8 | 9 | 1-1 | 60 | Blocked isocyanate BL3175 | 40 |
| | | | | | (solid content: 75%) | |
| Example 7 | I-10 | 5 | 1-1 | 60 | Blocked isocyanate BL3175 | 40 |
| | | | | | (solid content: 75%) | |
| Example 8 | I-1 | 5 | 1-1 | 50 | Blocked isocyanate BL3175 | 60 |
| | | | | | (solid content: 75%) | |
| Example 9 | I-1 | 5 | 1-1 | 78 | Blocked isocyanate BL3175 | 22.7 |
| | | | | | (solid content: 75%) | |
| Example 10 | I-1 | 5 | 2-1 | 60 | Blocked isocyanate BL3175 | 40 |
| | | | | | (solid content: 75%) | |
| Example 11 | I-1 | 5 | 1-1 | 60 | Methylated melamine resin | 35 |
| | | | | | MW-30 produced by SANWA | |
| | | | | | CHEMICAL CO., LTD. | |
| Example 12 | I-1 | 5 | 1-1 | 47 | Blocked isocyanate BL3175 | 64 |
| | | | | | (solid content: 75%) | |

| | | | | Environmental | |
|---|---|---|---|---|---|
| | | | | stability of | |
| | Butyral resin | | Charge | charge | |
| | | Amount [parts | retaining | retaining | Residual |
| | Type | by mass] | property | property | potential |
| Example 1 | — | 0 | G1 | G1 | G1 |
| Example 2 | S-LEC BL-S produced by | 5 | G1 | G2 | G1 |
| | SEKISUI CHEMICAL CO., LTD. | | | | |
| Example 3 | S-LEC BL-S produced by | 2.5 | G1 | G1 | G1 |
| | SEKISUI CHEMICAL CO., LTD. | | | | |
| Example 4 | S-LEC BL-S produced by | 5 | G1 | G2 | G1 |
| | SEKISUI CHEMICAL CO., LTD. | | | | |
| Example 5 | S-LEC BL-S produced by | 2.5 | G1 | G1 | G1 |
| | SEKISUI CHEMICAL CO., LTD. | | | | |
| Example 6 | S-LEC BL-S produced by | 1 | G1 | G1 | G1 |
| | SEKISUI CHEMICAL CO., LTD. | | | | |
| Example 7 | S-LEC BM-1 produced by | 5 | G1 | G2 | G1 |
| | SEKISUI CHEMICAL CO., LTD. | | | | |
| Example 8 | S-LEC BL-S produced by | 5 | G1 | G2 | G3 |
| | SEKISUI CHEMICAL CO., LTD. | | | | |
| Example 9 | S-LEC BL-S produced by | 5 | G2 | G2 | G2 |
| | SEKISUI CHEMICAL CO., LTD. | | | | |
| Example 10 | S-LEC BL-S produced by | 3 | G1 | G1 | G1 |
| | SEKISUI CHEMICAL CO., LTD. | | | | |
| Example 11 | — | 0 | G2 | G2 | G2 |
| Example 12 | S-LEC BL-S produced by | 5 | G1 | G3 | G3 |
| | SEKISUI CHEMICAL CO., LTD. | | | | |

TABLE 2

| | Reactive group-containing | | Electron transport | | | |
|---|---|---|---|---|---|---|
| | triarylamine compound | | material | | Curing agent | |
| | | Amount [parts | | Amount [parts | | Amount [parts |
| | Type | by mass] | Type | by mass] | Type | by mass] |
| Example 13 | I-1 | 5 | 1-1 | 81 | Blocked isocyanate BL3175 | 18.7 |
| | | | | | (solid content: 75%) | |
| Example 14 | I-1 | 7.5 | 3-5 | 60 | Blocked isocyanate BL3175 | 40 |
| | | | | | (solid content: 75%) | |
| Example 15 | I-1 | 7.5 | 4-7 | 60 | Blocked isocyanate BL3175 | 40 |
| | | | | | (solid content: 75%) | |
| Example 16 | I-1 | 7.5 | 5-8 | 60 | Blocked isocyanate BL3175 | 40 |
| | | | | | (solid content: 75%) | |
| Example 17 | I-1 | 7.5 | 6-2 | 60 | Blocked isocyanate BL3175 | 40 |
| | | | | | (solid content: 75%) | |
| Example 18 | I-1 | 7.5 | 7-2 | 60 | Blocked isocyanate BL3175 | 40 |
| | | | | | (solid content: 75%) | |
| Example 19 | I-1 | 7.5 | 8-3 | 60 | Blocked isocyanate BL3175 | 40 |
| | | | | | (solid content: 75%) | |
| Example 20 | I-1 | 11 | 1-1 | 60 | Blocked isocyanate BL3175 | 40 |
| | | | | | (solid content: 75%) | |
| Example 21 | I-1 | 0.05 | 1-1 | 60 | Blocked isocyanate BL3175 | 40 |
| | | | | | (solid content: 75%) | |
| Comparative | I-1 | 3.8 | 1-1 | 60 | Blocked isocyanate BL3175 | 40 |
| Example 1 | | | | | (solid content: 75%) | |
| Comparative | — | 0 | 1-1 | 60 | Blocked isocyanate BL3175 | 40 |
| Example 2 | | | | | | |
| Comparative | c1 | 5 | 1-1 | 60 | Blocked isocyanate BL3175 | 40 |
| Example 3 | | | | | | |

| | | | | Environmental | |
|---|---|---|---|---|---|
| | | | | stability of | |
| | Butyral resin | | Charge | charge | |
| | | Amount [parts | retaining | retaining | Residual |
| | Type | by mass] | property | property | potential |
| Example 13 | S-LEC BL-S produced by SEKISUI | 5 | G3 | G3 | G2 |
| | CHEMICAL CO., LTD. | | | | |
| Example 14 | S-LEC BL-S produced by SEKISUI | 2.5 | G1 | G1 | G3 |
| | CHEMICAL CO., LTD. | | | | |
| Example 15 | S-LEC BL-S produced by SEKISUI | 2.5 | G1 | G1 | G3 |
| | CHEMICAL CO., LTD. | | | | |
| Example 16 | S-LEC BL-S produced by SEKISUI | 2.5 | G1 | G1 | G3 |
| | CHEMICAL CO., LTD. | | | | |
| Example 17 | S-LEC BL-S produced by SEKISUI | 2.5 | G1 | G1 | G3 |
| | CHEMICAL CO., LTD. | | | | |
| Example 18 | S-LEC BL-S produced by SEKISUI | 2.5 | G1 | G1 | G3 |
| | CHEMICAL CO., LTD. | | | | |
| Example 19 | S-LEC BL-S produced by SEKISUI | 2.5 | G1 | G1 | G3 |
| | CHEMICAL CO., LTD. | | | | |
| Example 20 | S-LEC BL-S produced by SEKISUI | 2.5 | G1 | G1 | G2 |
| | CHEMICAL CO., LTD. | | | | |
| Example 21 | S-LEC BL-S produced by SEKISUI | 2.5 | G3 | G3 | G3 |
| | CHEMICAL CO., LTD. | | | | |
| Comparative | S-LEC BL-S produced by SEKISUI | 6.2 | G4 | G4 | G4 |
| Example 1 | CHEMICAL CO., LTD. | | | | |
| Comparative | S-LEC BL-S produced by SEKISUI | 5 | G4 | G4 | G2 |
| Example 2 | CHEMICAL CO., LTD. | | | | |
| Comparative | S-LEC BL-S produced by SEKISUI | 5 | G4 | G4 | G4 |
| Example 3 | CHEMICAL CO., LTD. | | | | |

The tables reveal that the electrophotographic photoreceptors of Examples have excellent charge-retaining properties and low residual potentials compared to the electrophotographic photoreceptors of Comparative Examples. The tables also reveal that the electrophotographic photoreceptors of Examples have excellent environmental stability of charge-retaining properties compared to the electrophotographic photoreceptors of Comparative Examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An electrophotographic photoreceptor comprising:
a conductive substrate;
an undercoat layer on the conductive substrate; and
a photosensitive layer on the undercoat layer,
wherein the undercoat layer is formed of a cured product of a composition that contains a reactive group-containing triarylamine compound, a curing agent, and an electron transport material and that has a butyral resin content of 0 mass % or more and 5 mass % or less relative to all solid components in the undercoat layer.

2. The electrophotographic photoreceptor according to claim 1, wherein the composition has a butyral resin content of 0 mass % or more and 4 mass % or less.

3. The electrophotographic photoreceptor according to claim 1, wherein the composition has a butyral resin content of 0 mass % or more and 3 mass % or less.

4. The electrophotographic photoreceptor according to claim 1, wherein the reactive group-containing triarylamine compound contains a hole transport compound represented by general formula (I) below: 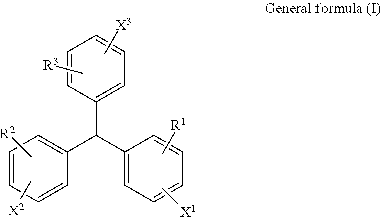
where, in general formula (I), R¹, R², and R³ each independently represent a hydrogen atom, a hydroxyl group, a hydroxyalkyl group having 1 to 6 carbon atoms, an amino group (NH₂ group), a thiol group, an alkylthiol group, a carboxy group, or a carboxyalkyl group, and X¹, X², and X³ each independently represent a halogen atom, an alkyl group, an alkoxy group, an ester group, an aryl group, an aralkyl group, or a vinylphenyl group.

5. The electrophotographic photoreceptor according to claim 4, wherein, in general formula (I), R¹, R², and R³ each independently represent a hydroxyl group, a hydroxyalkyl group having 1 to 4 carbon atoms, an amino group (NH₂ group), a carboxy group, or a carboxyalkyl group having 1 to 4 carbon atoms, and X¹, X², and X³ each independently represent an alkyl group having 1 to 3 carbon atoms, an aryl group, or a vinylphenyl group.

6. The electrophotographic photoreceptor according to claim 1, wherein the electron transport material contains at least one electron transport material selected from the group consisting of compounds represented by general formula (1), general formula (2), general formula (3), general formula (4), general formula (5), general formula (6), general formula (7), and general formula (8) below: 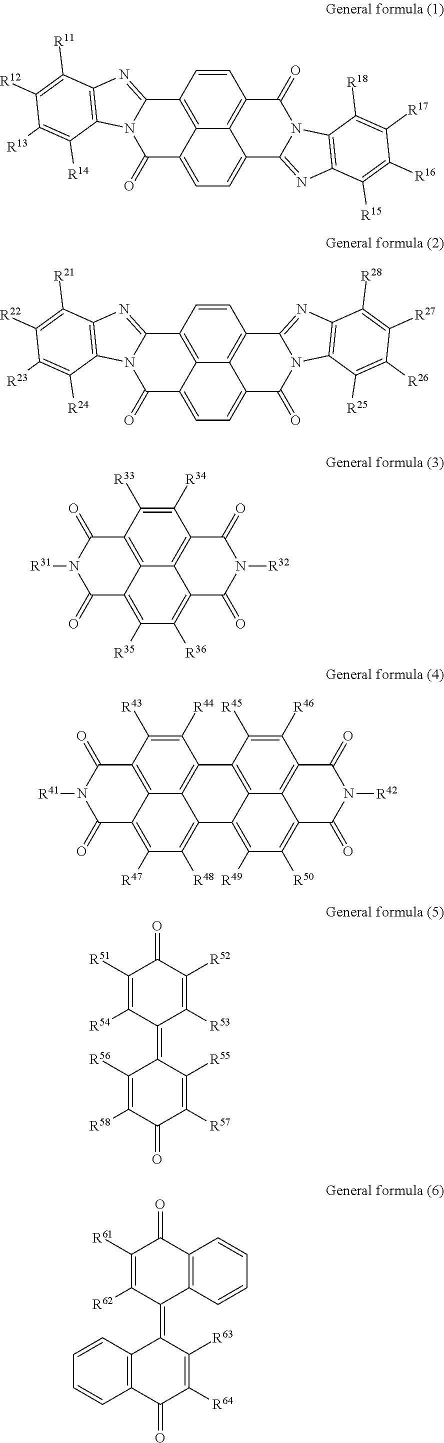 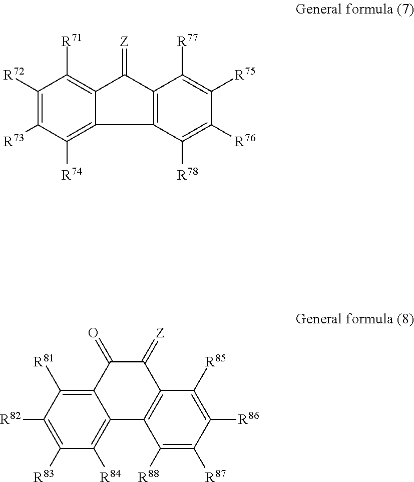
where:
in general formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom; R¹¹ and R¹² taken together may form a ring and so may R¹² and R¹³, and R¹³ and R¹⁴; and R¹⁵ and R¹⁶ taken together may form a ring, and so may R¹⁶ and R¹⁷, and R¹⁷ and R¹⁸,
in general formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom; R²¹ and R²² taken together may form a ring, and so may R²² and R²³, and R²³ and R²⁴; and R²⁵ and R²⁶ taken together may form a ring, and so may R²⁶ and R²⁷, and R²⁷ and R²⁸,
in general formula (3), R³¹, R³², R³³, R³⁴, R³⁵, and R³⁶ each independently represent a hydrogen atom, an alkyl group, an alkoxy group, an aralkyl group, an aryl group, an alkoxycarbonyl group, or a halogen atom,
in general formula (4), R⁴¹, R⁴², R⁴³, R⁴⁴, R⁴⁵, R⁴⁶, R⁴⁷, R⁴⁸, R⁴⁹, and R⁵⁰ each independently represent a hydrogen atom, an alkyl group, an alkoxy group, an aralkyl group, an aryl group, an alkoxycarbonyl group, or a halogen atom,
in general formula (5), R⁵¹, R⁵², R⁵³, R⁵⁴, R⁵⁵, R⁵⁶, R⁵⁷, and R⁵⁸ each independently represent a hydrogen atom, an alkyl group, an alkoxy group, an aralkyl group, an aryl group, an alkoxycarbonyl group, or a halogen atom,
in general formula (6), R⁶¹, R⁶², R⁶³, and R⁶⁴ each independently represent a hydrogen atom, an alkyl group, an alkoxy group, an aralkyl group, an aryl group, an alkoxycarbonyl group, or a halogen atom,
in general formula (7), R⁷¹, R⁷², R⁷³, R⁷⁴, R⁷⁵, R⁷⁶, R⁷⁷, and R⁷⁸ each independently represent a hydrogen atom, an alkyl group, an alkoxy group, an aralkyl group, an aryl group, an acyl group, an alkoxycarbonyl group, or a halogen atom, and Z represents an oxygen atom or a dicyanomethylene group (═C(CN)₂), and
in general formula (8), R⁸¹, R⁸², R⁸³, R⁸⁴, R⁸⁵, R⁸⁶, R⁸⁷, and R⁸⁸ each independently represent a hydrogen atom, an alkyl group, an alkoxy group, an aralkyl group, an aryl group, an acyl group, an alkoxycarbonyl group, or a halogen atom, and Z represents an oxygen atom or a dicyanomethylene group (═C(CN)₂).

7. The electrophotographic photoreceptor according to claim 1, wherein an amount of the reactive group-containing triarylamine compound contained relative to all solid components in the undercoat layer is 0.1 mass % or more and 10 mass % or less.

8. The electrophotographic photoreceptor according to claim 7, wherein the amount of the reactive group-containing triarylamine compound contained relative to all solid components in the undercoat layer is 0.1 mass % or more and 8 mass % or less.

9. The electrophotographic photoreceptor according to claim 8, wherein the amount of the reactive group-containing triarylamine compound contained relative to all solid components in the undercoat layer is 2 mass % or more and 5 mass % or less.

10. The electrophotographic photoreceptor according to claim 1, wherein an amount of the electron transport material contained relative to all solid components in the undercoat layer is 50 mass % or more and 80 mass % or less.

11. The electrophotographic photoreceptor according to claim 10, wherein the amount of the electron transport material contained relative to all solid components in the undercoat layer is 55 mass % or more and 75 mass % or less.

12. The electrophotographic photoreceptor according to claim 11, wherein the amount of the electron transport material contained relative to all solid components in the undercoat layer is 60 mass % or more and 70 mass % or less.

13. A process cartridge detachably attachable to an image forming apparatus, the process cartridge comprising the electrophotographic photoreceptor according to claim 1.

14. An image forming apparatus comprising:
the electrophotographic photoreceptor according to claim 1;
a charging unit that charges a surface of the electrophotographic photoreceptor;
an electrostatic latent image forming unit that forms an electrostatic latent image on the charged surface of the electrophotographic photoreceptor;
a developing unit that develops the electrostatic latent image on the surface of the electrophotographic photoreceptor by using a developer containing a toner so as to form a toner image; and
a transfer unit that transfers the toner image onto a surface of a recording medium.
